(19) United States
(12) Patent Application Publication
(10) Pub. No.: US 2024/0402321 A1
(43) Pub. Date: Dec. 5, 2024

(54) DISTANCE MEASURING DEVICE, DISTANCE MEASURING METHOD, AND STORAGE MEDIUM HAVING PROGRAM STORED THEREON

(71) Applicant: NEC Corporation, Minato-ku, Tokyo (JP)

(72) Inventors: Yuki ASHINO, Tokyo (JP); Masahiro KARUBE, Tokyo (JP); Takashi HITANI, Tokyo (JP)

(73) Assignee: NEC Corporation, Minato-ku, Tokyo (JP)

(21) Appl. No.: 18/697,757

(22) PCT Filed: Oct. 11, 2022
(86) PCT No.: PCT/JP2022/037870

§ 371 Date: Apr. 2, 2024

(30) Foreign Application Priority Data
Oct. 21, 2021 (JP) 2021-172487
Mar. 2, 2022 (JP) 2022-031629

(51) Int. Cl. G01S 11/08; G01S 5/02; G01S 5/12; G01S 5/14

(52) U.S. Cl. CPC G01S 11/08; G01S 5/0295; G01S 5/12; G01S 5/145

(57) ABSTRACT

A distance measuring device provided with measuring means for acquiring a transmission timing at which a probe packet was transmitted to a probe target, and a reception timing at which a response packet to the probe packet was received from the probe target; response time calculating means for calculating a response time by using the transmission timing and the reception timing; medium storing means for storing a medium velocity, which is a signal transmission velocity in a transmission medium used for transmission between a distance measuring device and the probe target; and distance calculating means for calculating a distance to the probe target by using the response time and the medium velocity.

### TECHNICAL FIELD

The present invention relates to a distance measuring device, a distance measuring method, and a storage medium having a program stored thereon.

### BACKGROUND ART

In general, signals arrive at a counterpart with a delay that is proportional to the physical distance thereto. For distance measurements in the case of radio waves, since the propagation velocity in air, which is the medium, is constant, there are radars that accurately measure the distance to an object towards which radio waves have been emitted by measuring the time until the emitted radio waves are reflected and return. In data communication, as with radio waves, data arrives at a communication counterpart with a delay that is proportional to the physical distance thereto. For example, technologies for “measuring the length of an optical fiber” connecting two points at clearly defined locations have been proposed (see, for example, Patent Document 1). In the technology described in Patent Document 1, there is no problem in treating the medium velocity to be unvarying because it is assumed that there are no media or devices other than the optical fiber between the two points.

### CITATION LIST

### Patent Literature

[Patent Document 1] Japanese Unexamined Patent Application, First Publication No. 2014-90262

### SUMMARY OF THE INVENTION

### Problems to be Solved by the Invention

However, in data communication, unlike the reflection of radio waves, the propagation velocities through communication media are unclear. Thus, it is difficult to measure distances by measuring the time until a communication counterpart responds. Furthermore, the technology described in Patent Document 1 was not able to handle cases in which there are media other than the optical fiber between the two points with the communication equipment, multiple communication devices are inserted, or the medium velocity changes. Thus, with related technology, it was difficult to measure distances from response times because the propagation velocities in communication media located between the source and the communication counterpart are unclear.

The present invention has the purpose of providing a distance measuring device, a distance measuring method, and a storage medium having a program stored thereon, which solve the problem described above.

### Means for Solving the Problems

In order to solve the above-mentioned problem, the distance measuring device according to a first aspect of the present application is provided with measuring means for acquiring a transmission timing at which a probe packet was transmitted to a probe target, and a reception timing at which a response packet to the probe packet was received from the probe target; response time calculating means for calculating a response time by using the transmission timing and the reception timing; medium storing means for storing a medium velocity, which is a signal transmission velocity in a transmission medium used for transmission between the distance measuring device and the probe target; and distance calculating means for calculating a distance to the probe target by using the response time and the medium velocity.

Additionally, the distance measuring method according to a second aspect of the present application includes acquiring a transmission timing at which a probe packet was transmitted to a probe target, and a reception timing at which a response packet to the probe packet was received from the probe target; calculating a response time by using the transmission timing and the reception timing; storing a medium velocity, which is a signal transmission velocity in a transmission medium used for transmission between a distance measuring device and the probe target; and calculating a distance to the probe target by using the response time and the medium velocity.

Additionally, the program stored on a storage medium according to a third aspect of the present application makes a computer execute a process for acquiring a transmission timing at which a probe packet was transmitted to a probe target, and a reception timing at which a response packet to the probe packet was received from the probe target; calculating a response time by using the transmission timing and the reception timing; storing a medium velocity, which is a signal transmission velocity in a transmission medium used for transmission between a distance measuring device and the probe target; and calculating a distance to the probe target by using the response time and the medium velocity.

### Advantageous Effects of Invention

According to the present invention, distances to communication counterparts can be measured.

### BRIEF DESCRIPTION OF THE DRAWINGS

FIG. 1 A diagram indicating examples of factors affecting response times.

FIG. 2 A diagram illustrating a configuration example of a distance measuring device according to an embodiment.

FIG. 3 A diagram illustrating a configuration example of a distance measuring system according to a first embodiment.

FIG. 4 A diagram illustrating a hardware configuration example of a distance measuring device.

FIG. 5 A diagram indicating examples of information stored in a medium DB according to a first embodiment.

FIG. 6 A flow chart of the processing procedure in the distance measuring device according to the first embodiment.

FIG. 7 A diagram indicating examples of information relating to distance presented on a display device according to the first embodiment.

FIG. 8 A diagram illustrating a configuration example of a distance measuring system according to a second embodiment.

FIG. 9 A diagram indicating examples of information stored in a measurement results DB according to the second embodiment.

FIG. 10 A diagram indicating examples of information stored in a measuring device DB according to the second embodiment.

FIG. 11 A flow chart of the processing procedure in the distance measuring device according to the second embodiment.

FIG. 12 A diagram illustrating a first example of information relating to distance presented on a display device according to the second embodiment.

FIG. 13 A diagram illustrating a second example of information relating to distance presented on a display device according to the second embodiment.

FIG. 14 A diagram illustrating a configuration example of a distance measuring system according to a third embodiment.

FIG. 15 A diagram indicating examples of information stored in a measurement results DB according to the third embodiment.

FIG. 16 A diagram indicating examples of information stored in a medium DB according to the third embodiment.

FIG. 17 A flow chart of the processing procedure in the distance measuring device according to the third embodiment.

FIG. 18 A flow chart of the distance calculation procedure in the medium velocity calculation unit according to the third embodiment.

FIG. 19 A diagram illustrating a configuration example of a distance measuring system according to a fourth embodiment.

FIG. 20 A diagram indicating examples of information stored in a measurement results DB according to the fourth embodiment.

FIG. 21 A diagram indicating examples of information stored in a medium DB according to the fourth embodiment.

FIG. 22 A flow chart of the processing procedure in the distance measuring device according to the fourth embodiment.

FIG. 23 A diagram illustrating a configuration example of a distance measuring system according to the fifth embodiment.

FIG. 24 A diagram indicating examples of observed packets.

FIG. 25 A diagram indicating examples of information stored in a response time calculation method DB according to a fifth embodiment.

FIG. 26 A diagram indicating examples of information stored in a calculation policy DB according to the fifth embodiment.

FIG. 27 A diagram illustrating a configuration example of a distance measuring system according to a sixth embodiment.

FIG. 28 A diagram indicating examples of terrain policy information according to the sixth embodiment.

FIG. 29 A diagram indicating an example of a plot in the case in which there are three measurement units.

FIG. 30 A flow chart of the processing procedure in the distance measuring device according to the sixth embodiment.

FIG. 31 A diagram indicating examples of results of measurements using four measurement units.

FIG. 32 An illustrative diagram for the case in which circles of position ranges do not overlap.

### EXAMPLE EMBODIMENT

Hereinafter, embodiments will be explained with reference to the drawings. In the drawings used for the explanation below, the scales of the respective components are changed, as appropriate, to sizes allowing the respective components to be recognized.

First, a summary of the communication process for the case in which communication is performed between communication equipment will be explained.

Transmission paths between communication equipment go through undersea cables and overland communication lines, and the farther the distances become, the more they approximate straight-line distances. The communication is based on packet exchange. For this reason, when a communication device or a personal computer (hereinafter referred to as a “PC”) exceeds the limit of packet processing capacity, a “wait” occurs. This waiting time is not limited to abnormal situations such as DDOS (Distributed Denial of Service) and access concentration, and can be estimated to have a distribution close to a normal distribution.

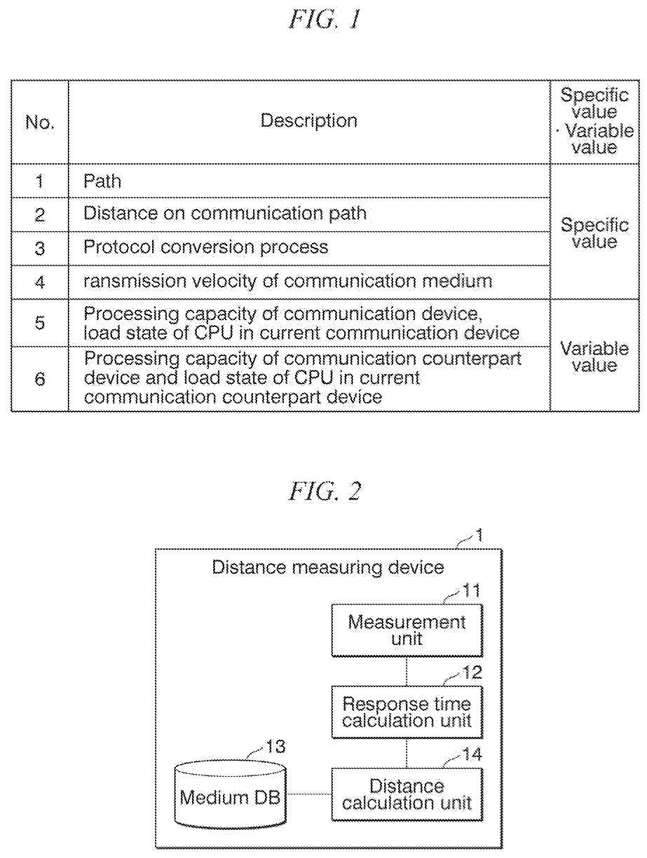

FIG. 1 is a diagram indicating examples of factors affecting response times. As indicated in FIG. 1, the factors affecting response times include, for example, the six indicated below.

### I. Path

The path changes every few minutes to hours. When the path changes, the distance changes.

### II. Distance on Communication Path

The distances between points are fixed. However, there is a possibility that the points will be changed on a yearly basis.

### III. Protocol Conversion Process

Delays (a few ms or less) occur when converting protocols, for example, from ethernet (registered trademark) to ATM (Asynchronous Transfer Mode), from ATM to optical signals, from optical signals to ATM, and from ATM to ethernet.

### IV. Transmission Velocity of Communication Medium

The transmission velocities of optical fibers, undersea cables, and metallic cables are fixed. For example, the transmission velocity of a metallic cable is approximately 300,000 (km/s) and the transmission velocity of an optical fiber is approximately 200,000 (km/s).

### V. Processing Capacity of Communication Device, Load State of CPU (Central Processing Unit) in Current Communication Device

Delays (a few milliseconds for each packet) in wait queue processing occur under the influence of the processing capacity of the communication device and the load state of the CPU in a current communication device. This fluctuates under the influence of the properties (sequential processing) of packet exchange.

### VI. Processing Capacity of Communication Counterpart PC and Load State of CPU in Current Communication Counterpart PC

Delays in wait queue processing occur under the influence of the processing capacity of the communication counterpart PC and the load state of the CPU in a current communication counterpart PC. This fluctuates, for example, under the influence of the properties (sequential processing, memory expansion, processing) of a Neumann-type PC.

Among the factors mentioned above, I to IV are specific values, and V and VI are variable values.

FIG. 2 is a diagram illustrating a configuration example of a distance measuring device according to an embodiment. As shown in FIG. 2, the distance measuring device 1 is provided with a measurement unit 11, a response time calculation unit 12, a medium DB 13, and a distance calculation unit 14. The measurement unit 11 corresponds to an example of a measuring means. The response time calculation unit 12 corresponds to an example of a response time calculating means. The medium DB 13 corresponds to an example of a medium storing means. The distance calculation unit 14 corresponds to an example of a distance calculating means.

The distance measuring device 1 measures the distance between the distance measuring device 1 and a probe target, and presents information relating to the measured distance on a display device. The distance measuring device 1 and the probe target are connected by a transmission medium. The transmission medium is, for example, an optical fiber, a metallic cable, etc.

The measurement unit 11 transmits a probe packet P to the probe target and receives a response packet R from the probe target. The measurement unit 11 acquires a transmission timing Tp at which the probe packet P was transmitted, and a reception timing Tr at which the response packet R was received.

The response time calculation unit 12 uses the transmission timing Tp and the reception timing Tr to calculate a response time R.

The medium DB 13 is a database that stores medium velocities for different transmission media.

The distance calculation unit 14 acquires, from the medium DB 13, a medium velocity Vm, which is the signal transmission velocity in the transmission medium between the distance measuring device 1 and the probe target. The transmission medium between the distance measuring device 1 and the probe target is known. The distance calculation unit 14 uses the response time R and the medium velocity Vm to calculate the distance. The distance calculation unit 14 presents information relating to the calculated distance on a display device.

### First Embodiment

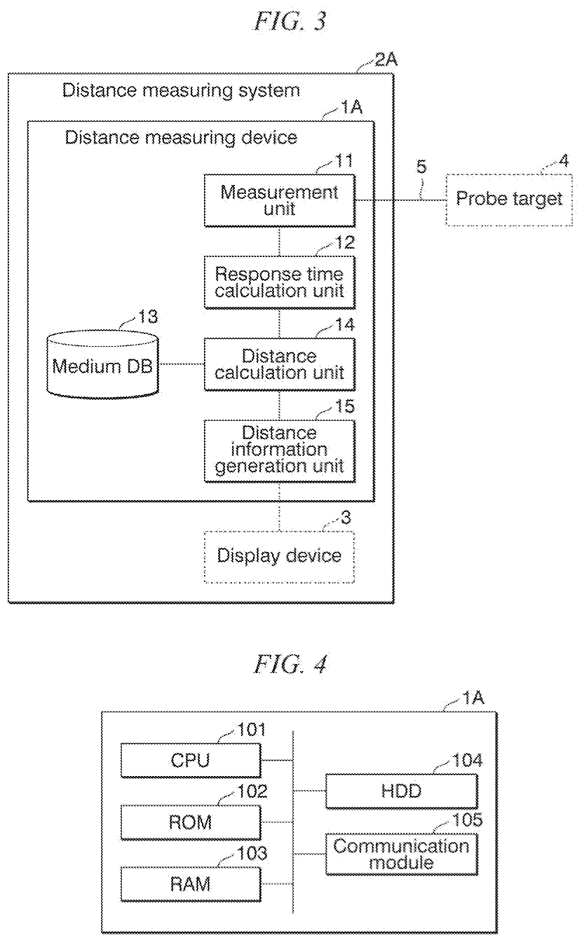

FIG. 3 is a diagram illustrating a configuration example of a distance measuring system according to the present embodiment. As shown in FIG. 3, the distance measuring system 2A is provided with a distance measuring device 1A and a display device 3. The distance measuring device 1A is provided with a measurement unit 11, a response time calculation unit 12, a medium DB 13, a distance calculation unit 14, and a distance information generation unit 15. The measurement unit 11 corresponds to an example of a measuring means. The response time calculation unit 12 corresponds to an example of a response time calculating means. The medium DB 13 corresponds to an example of a medium storing means. The distance calculation unit 14 corresponds to an example of a distance calculating means. The distance information generation unit 15 corresponds to an example of a distance information generating means.

The distance measuring device 1A measures the distance between the distance measuring device 1A and a probe target 4, and presents information relating to the measured distance on a display device 3. The distance measuring device 1A and the probe target 4 are connected by a transmission medium 5.

The display device 3 is, for example, a liquid-crystal image display device or an organic EL (ElectroLuminescent) image display device. The display device 3 may, for example, be a tablet terminal, a smartphone, a dedicated terminal, a printing device, etc.

The measurement unit 11 transmits a probe packet P to the probe target 4 and receives a response packet R from the probe target 4. The measurement unit 11 acquires a transmission timing Tp at which the probe packet P was transmitted, and a reception timing Tr at which the response packet R was received.

The response time calculation unit 12 uses the transmission timing Tp, the reception timing Tr, and the following Expression (1) to calculate a response time R.

$$\begin{matrix}[ Mathematical Expression 1 ] & \\ R = Tr - Tp & ( 1 )\end{matrix}$$

The medium DB 13 is a database that stores medium velocities for various types of transmission media.

The distance calculation unit 14 acquires, from the medium DB 13, a medium velocity Vm in the transmission medium between the distance measuring device 1A and the probe target 4. The transmission medium between the distance measuring device 1A and the probe target 4 is known. The distance calculation unit 14 uses the following Expression (2) to calculate the distance.

$$\begin{matrix}[ Mathematical Expression 2 ] & \\ Distance = R \times ( Vm \div 2 ) & ( 2 )\end{matrix}$$

The distance information generation unit 15 generates information relating to the calculated distance and presents the generated information relating to the distance on the display device 3. Examples of the information presented on the display device 3 will be described below.

FIG. 4 is a diagram illustrating a hardware configuration example of a distance measuring device.

The distance measuring device 1A illustrated in FIG. 4 is, for example, a computer provided with hardware such as, for example, a CPU (Central Processing Unit) 101, a ROM (Read-Only Memory) 102, a RAM (Random Access Memory) 103, an HDD (Hard Disk Drive) 104, and a communication module 105.

The CPU 101 in the distance measuring device 1A is provided with the measurement unit 11, the response time calculation unit 12, the distance measurement unit 14, and the distance information generation unit 15 illustrated in FIG. 3 by executing a program stored in memory.

FIG. 5 is a diagram indicating examples of information stored in the medium DB according to the present embodiment. As shown in FIG. 5, the medium DB 13 stores, for example, medium velocities for various types of transmission media. Multiple medium velocities may be stored in association with the same transmission medium. As mentioned above, the transmission media are, for example, optical fibers, metallic cables, etc. The medium velocity is the signal transmission velocity (km/s) in the transmission medium 5 used for transmission between the distance measuring device 1A and the probe target 4.

Next, an example of the processing procedure in the distance measuring device 1A will be explained.

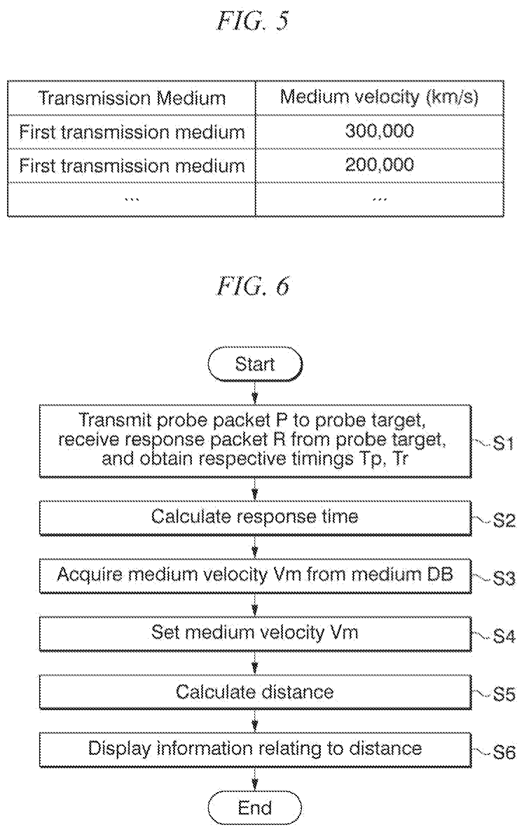

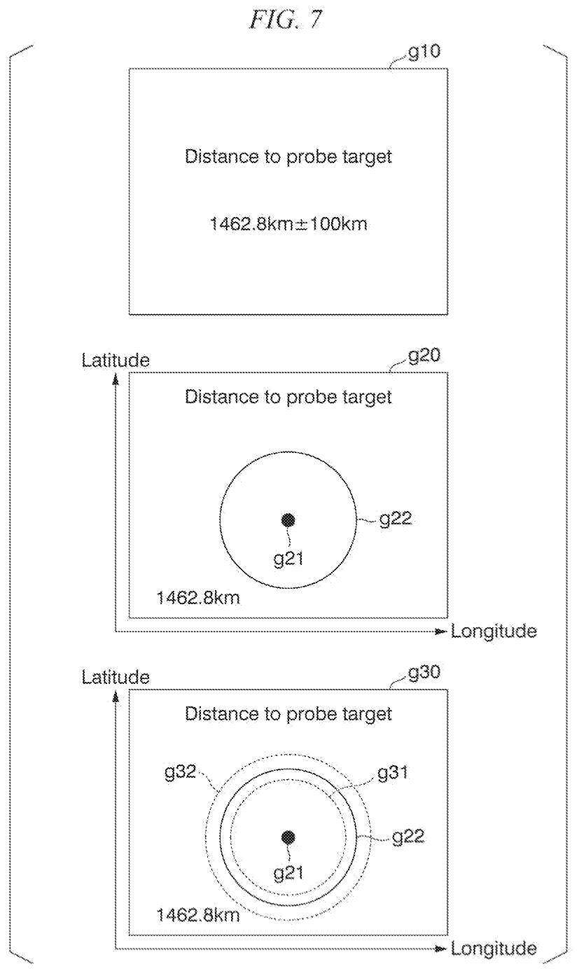

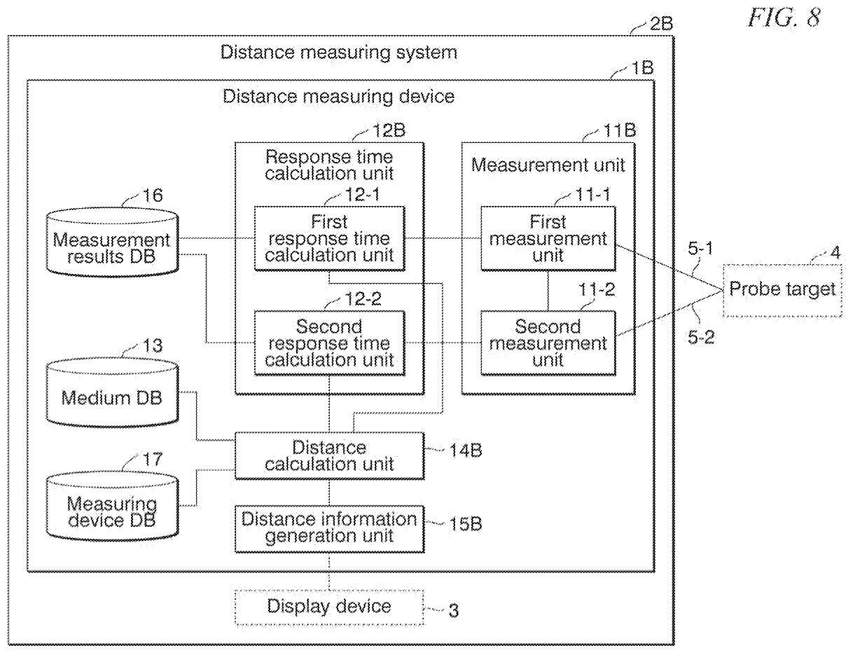

FIG. 6 is a flow chart of the processing procedure in the distance measuring device according to the present embodiment.

(Step S1) The measurement unit 11 transmits a probe packet P to the probe target 4 and receives a response packet R from the probe target 4. The measurement unit 11 acquires a transmission timing Tp at which the probe packet P was transmitted and a reception timing Tr at which the response packet R was received.

(Step S2) The response time calculation unit 12 uses the transmission timing Tp, the reception timing Tr, and Expression (1) to calculate the response time R.

(Step S3) The distance calculation unit 14 acquires the medium velocity Vm in the transmission medium between the distance measuring device 1A and the probe target 4 from the medium DB 13.

(Step S4) The distance calculation unit 14 is set to the acquired medium velocity Vm.

(Step S5) The distance calculation unit 14 uses Expression (2) to calculate the distance between the distance measuring device 1A and the probe target 4.

(Step S6) The distance information generation unit 15 generates information relating to the calculated distance and presents the generated information relating to the distance on the display device 3.

Next, measurement values and examples of calculation results will be explained.

In the case in which the transmission timing Tr is 10:12 and 13.091183 seconds, and the reception timing Tr is 10:12 and 13.105811 seconds, the response time R is 0.014628 (seconds)=(10:12:13.105811-10:12:13.091183).

In this example, the medium is an optical fiber. Therefore, the distance calculation unit 14 acquires the value 200,000 (km/s) as the medium velocity Vm from the medium DB 13. Furthermore, the distance calculation unit 14 calculates the distance to be 1462.8 (km) (=0.014628×(200,000 (km/s)+2).

Next, an example of information relating to distance presented on the display device 3 will be explained.

FIG. 7 is a diagram illustrating an example of information relating to distance presented on the display device according to the present embodiment.

The display image example g10 is an example of information relating to a first distance. In this case, the calculated distance is presented as a number. Alternatively, it may be presented by appending a prescribed range (e.g., +5%) to the calculated distance.

The display image example g20 is an example of information relating to a second distance. In this case, the distance is presented as a number, together with the position g21 of the distance measuring device 1 and a circle g22 as a distance range. The circle g22 is a circle centered at the position g21 of the distance measuring device 1, and having a radius equal to the calculated distance. The distance information generation unit may display, for example, a map in overlay on this circle.

The display image example g30 is an example of information relating to a third distance. In this case, the information relating to the second distance is presented with, for example, +5% (g32), and for example, −5% (g31) appended thereto. The dotted-line circle g32 is a circle centered at the position g21 of the distance measuring device 1 and with a radius equal to a distance that is the calculated distance +5%. The dotted-line circle g31 is a circle centered at the position g21 of the distance measuring device 1 and with a radius equal to a distance that is the calculated distance −5%. In this case also, the distance information generation unit 15 may present a map in overlay on the circles. Additionally, in the display image examples g20 and g30, for example, the horizontal direction represents longitude and the vertical direction represents latitude.

The information relating to the distance presented on the display device 3 indicated in FIG. 7 is an example, and the disclosure is not limited thereto. For example, the information relating to distance presented on the display device 3 may be in table form, etc.

As described above, in the present embodiment, propagation velocities in communication media that were able to be established by prior investigation, etc. were used to measure distance based on a response time from a communication counterpart.

Thus, according to the present embodiment, the distance from a communication counterpart can be measured and the distance to a probe target can be accurately determined.

### Second Embodiment

FIG. 8 is a diagram illustrating a configuration example of a distance measuring system according to the present embodiment. As shown in FIG. 8, the distance measuring system 2B is provided with a distance measuring device 1B and a display device 3. The distance measuring device 1B is provided with a measurement unit 11B, a response time calculation unit 12B, a medium DB 13B, a distance calculation unit 14B, a distance information generation unit 15B, a measurement results DB 16, and a measuring device DB 17.

The measurement unit 11B is provided with a first measurement unit 11-1 and a second measurement unit 11-2.

The response time calculation unit 12B is provided with a first response time calculation unit 12-1 and a second response time calculation unit 12-2. The first measurement unit 11-1 and the probe target 4 are connected by a transmission medium 5-1. The second measurement unit 11-2 and the probe target 4 are connected by a transmission medium 5-2.

The distance measuring device 1B uses the medium velocity and the two response times measured respectively by the first measurement unit 11-1 and the second measurement unit 11-2 to calculate the distance.

The first measurement unit 11-1 transmits a probe packet P₁ to the probe target 4 through the transmission medium 5-1, and receives a response packet R₁ from the probe target 4. The first measurement unit 11-1 acquires a first transmission timing Tp₁ at which the probe packet P₁ was transmitted, and a first reception timing Tr₁ at which the response packet R₁ was received.

The second measurement unit 11-2 transmits a probe packet P₂ to the probe target 4 through the transmission medium 5-2, and receives a response packet R₂ from the probe target 4. The second measurement unit 11-2 acquires a second transmission timing Tp₂ at which the probe packet P₂ was transmitted, and a second reception timing Tr₂ at which the response packet R₂ was received. The first measurement unit 11-1 and the second measurement unit 11-2 are respectively located at different positions (latitude and longitude).

The first response time calculation unit 12-1 uses the first transmission timing Tp₁, the first reception timing Tr₁, and the following Expression (3) to calculate a first response time RTT₁. The first response time calculation unit 12-1 stores the calculated first response time RTT₁ in the measurement results DB 16.

$$\begin{matrix}[ Mathematical Expression 3 ] & \\ R T {T}_{1} = {Tr}_{1} - {Tp}_{1} & ( 3 )\end{matrix}$$

The second response time calculation unit 12-2 uses the second transmission timing Tp₂, the second reception timing Tr₂, and the following Expression (4) to calculate a second response time RTT₂. The second response time calculation unit 12-2 stores the calculated second response time RTT₂ in the measurement results DB 16.

$$\begin{matrix}[ Mathematical Expression 4 ] & \\ R T {T}_{2} = {Tr}_{2} - {Tp}_{2} & ( 4 )\end{matrix}$$

The measurement results DB 16 is a database that stores, for example, in association with identification information for an n-th measurement unit 11-n (where n is the integer 1 or 2), information indicating a probe target (e.g., an IP (Internet Protocol) address) and a response time RTT.

The measuring device DB 17 is a database that stores, for example, in association with identification information for an n-th measurement unit 11-n, position information (e.g., latitude and longitude) for the position at which the n-th measurement unit 11-n is installed.

The distance calculation unit 14B acquires, from the medium DB 13, the medium velocity Vm in the transmission medium between the distance measuring device 1B and the probe target 4. The transmission medium between the distance measuring device 1B and the probe target 4 is known. The distance calculation unit 14B uses the following Expression (5) and the following Expression (6) to calculate a first distance₁ and a second distance₂.

$$\begin{matrix}[ Mathematical Expression 5 ] & \\ {Distance}_{1} = R T {T}_{1} \times ( Vm \div 2 ) & ( 5 )\end{matrix}$$

$$\begin{matrix}[ Mathematical Expression 6 ] & \\ {Distance}_{2} = RT {T}_{2} \times ( Vm \div 2 ) & ( 6 )\end{matrix}$$

The distance information generation unit 15B uses the first distance₁ and the second distance₂ that have been calculated to generate information relating to the distance, and presents the generated information relating to the distance on the display device 3.

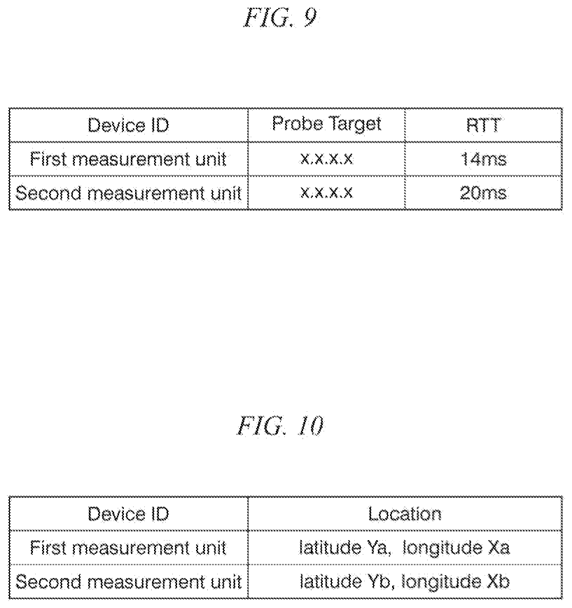

FIG. 9 is a diagram indicating examples of information stored in the measurement results DB according to the present embodiment. As shown in FIG. 9, the measurement results DB 16 stores, for example, in association with identification information for an n-th measurement unit 11-n, information indicating a probe target (e.g., an IP address) and a response time RTT.

FIG. 10 is a diagram indicating examples of information stored in the measuring device DB according to the present embodiment. As shown in FIG. 10, the measuring device DB 17 stores, for example, in association with identification information for an n-th measurement unit 11-n, position information (e.g., latitude and longitude) of the position at which the n-th measurement unit 11-n is installed.

Next, an example of the processing procedure in the distance measuring device 1B will be explained.

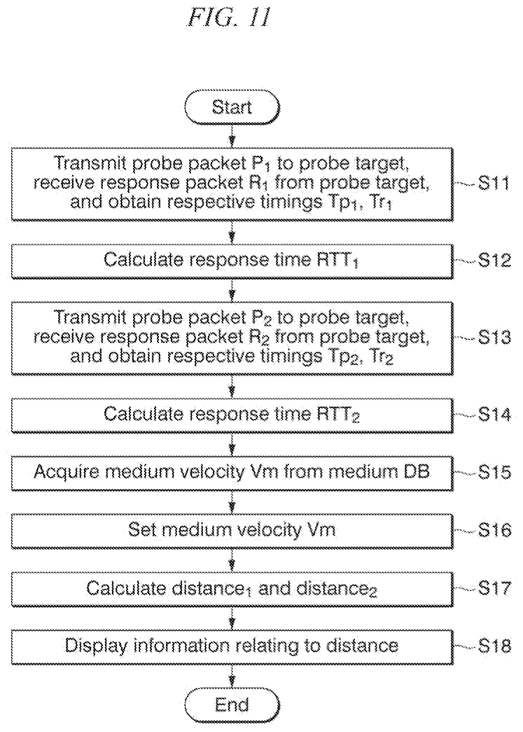

FIG. 11 is a flow chart of the processing procedure in the distance measuring device according to the present embodiment.

(Step S11) The first measurement unit 11-1 transmits a probe packet P₁ to the probe target 4 and receives a response packet R₁ from the probe target 4. The first measurement unit 11-1 acquires a first transmission timing Tp₁ at which the probe packet P₁ was transmitted and a first reception timing Tr at which the response packet R₁ was received.

(Step S12) The first response time calculation unit 12-1 uses the first transmission timing Tp₁, the first reception timing Tr₁, and Expression (3) to calculate the first response time RTT₁.

(Step S13) The second measurement unit 11-2 transmits a probe packet P₂ to the probe target 4 and receives a response packet R₂ from the probe target 4. The second measurement unit 11-2 acquires a second transmission timing Tp₂ at which the probe packet P₂ was transmitted and a second reception timing Tr₂ at which the response packet R₂ was received.

(Step S14) The second response time calculation unit 12-2 uses the second transmission timing Tp₂, the second reception timing Tr₂, and Expression (4) to calculate the second response time RTT₂.

(Step S15) The distance calculation unit 14B acquires the medium velocity Vm in the transmission medium between the distance measuring device 1B and the probe target 4 from the medium DB 13.

(Step S16) The distance calculation unit 14B is set to the acquired medium velocity Vm.

(Step S17) The distance calculation unit 14B uses Expression (5) to calculate a first distance between the first distance measurement unit 11-1 and the probe target 4. The distance calculation unit 14B uses Expression (6) to calculate a second distance₂ between the second distance measurement unit 11-2 and the probe target 4.

(Step S18) The distance information generation unit 15B generates information relating to the first distance, and the second distance₂ that have been calculated and presents the generated information relating to distance on the display device 3.

Next, an example of information relating to distance presented on the display device 3 will be explained.

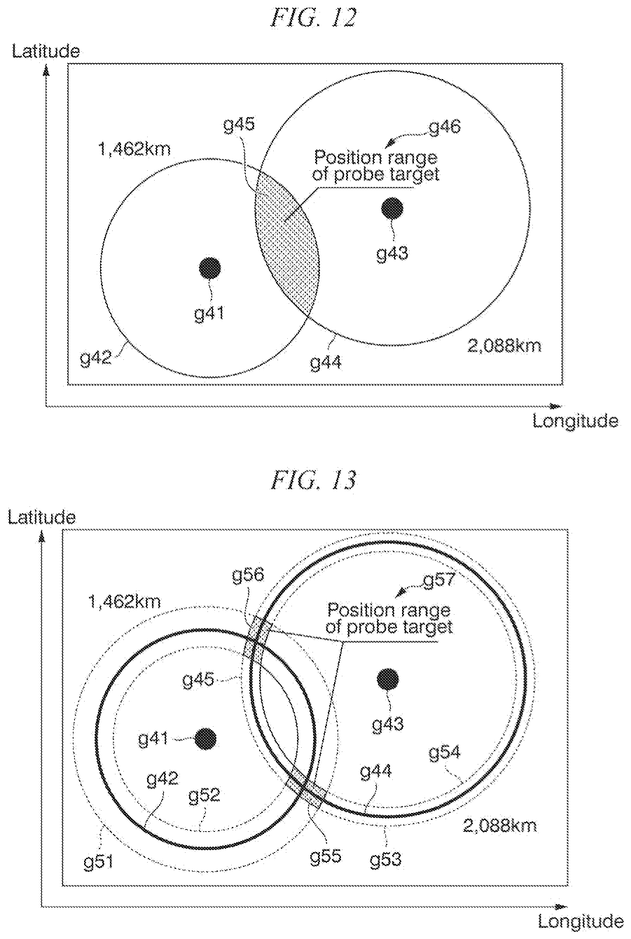

FIG. 12 is a diagram illustrating a first example of information relating to distance presented on the display device according to the present embodiment. The example in FIG. 12 presents a number that is the distance measured by the first measurement unit 11-1 together with the position g41 of the first measurement unit 11-1 and a first circle g42 indicating a distance range, a number that is the distance measured by the second measurement unit 11-2 together with the position g43 of the second measurement unit 11-2 and a second circle g44 indicating a distance range, and an area g45 of overlap between the two distance ranges. The circle g42 is a circle centered at the position g41 of the first measurement unit 11-1 and having a radius equal to the calculated first distance₁. The circle g44 is a circle centered at the position g43 of the second measurement unit 11-2 and having a radius equal to the calculated second distance₂. The distance information generation unit 15B may present the area g45 of overlap between the first circle g42 and the second circle g44 in a state different from that of the circles, etc. (e.g., differences in filling, hatching, coloring, or shading). Additionally, as shown in FIG. 12, the text “Position range of probe target” explaining the overlap area g45 may be displayed on the display device 3 using indicator lines, etc. (g46). In FIG. 12, for example, the horizontal direction represents longitude and the vertical direction represents latitude. The distance information generation unit 15B may display, for example, a map in overlay on these circles.

FIG. 13 is a diagram indicating a second example of information relating to distance presented on the display device according to the present embodiment. In the example in FIG. 13, in addition to the presentation example in FIG. 12, the circles (g42, g44) of the respective distance ranges are presented with, for example, −5% (g52, g54), and for example, +5% (g51, g53), as well as the areas g55, g56 where the distance ranges overlap, appended thereto.

The dotted-line circle g51 is a circle centered at the position g41 of the first measurement unit 11-1 and with a radius equal to a distance that is the first distance₁+5%, and the dotted-line circle g52 is a circle centered at the position g41 and with a radius equal to a distance that is the first distance₁−5%. The dotted-line circle g53 is a circle centered at the position g43 of the second measurement unit 11-2 and with a radius equal to a distance that is the second distance₂+5%, and the dotted-line circle g54 is a circle centered at the position g43 and with a radius equal to a distance that is the second distance₂−5%.

Additionally, as shown in FIG. 13, the text “Position range of probe target” explaining the overlap areas g55, g56 may be displayed on the display device 3 using indicator lines, etc. (g57). The overlap areas g55, g56 are areas at which the area in the distance range between the circumference of the circle g52 and the circumference of the circle g51 overlaps with the area in the distance range between the circumference of the circle g54 and the circumference of the circle g53. The distance information generation unit 15B may display a map in overlay on the circles in this case as well. Additionally, in the display image example, for example, the horizontal direction represents longitude and the vertical direction represents latitude.

The information relating to distance presented on the display device 3 indicated in FIGS. 12 and 13 is an example, and the disclosure is not limited thereto.

In the example described above, an example in which there are two measurement units was explained. However, there may be three or more measurement units (the first measurement unit 11-1, the second measurement unit 11-2, the third measurement unit 11-3, . . . ). In this case, distances may be determined and displayed for each of three response times. In the case in which a third point is used, the possible areas can be narrowed to a single area. In the case in which three or more measurement units are used, the area of overlap between the areas of the distance ranges is narrowed to a single area.

As described above, in the present embodiment, response times are measured by using two measurement units (the first measurement unit 11-1 and the second measurement unit 11-2).

Thus, according to the present embodiment, the distance from a communication counterpart can be measured. According to the present embodiment, two-point positioning is used. Thus, the position at which the probe target is located can be narrowed further than in the first embodiment from the range of overlap of the distance ranges based on the two response times.

### Third Embodiment

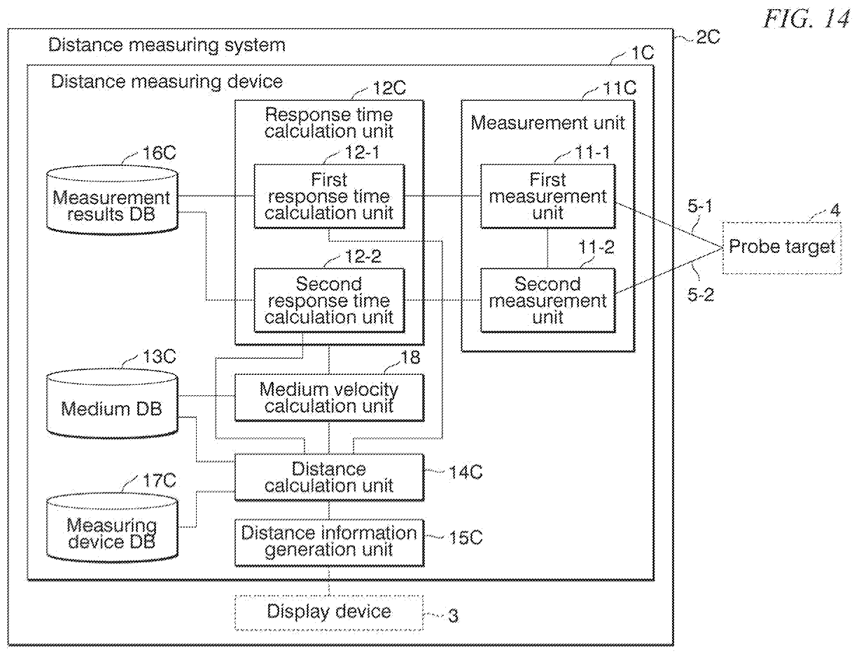

FIG. 14 is a diagram illustrating a configuration example of a distance measuring system according to the present embodiment. As shown in FIG. 14, the distance measuring system 2C is provided with a distance measuring device 1C and a display device 3. The distance measuring device 1C is provided with a measurement unit 11C, a response time calculation unit 12C, a medium DB 13C, a distance calculation unit 14C, a distance information generation unit 15C, a measurement results DB 16C, a measuring device DB 17C, and a medium velocity calculation unit 18.

The measurement unit 11C is provided with a first measurement unit 11-1 and a second measurement unit 11-2.

The response time calculation unit 12C is provided with a first response time calculation unit 12-1 and a second response time calculation unit 12-2.

The measurement unit 11C corresponds to an example of a measuring means. The first measurement unit 11-1 corresponds to an example of a first measuring means, a second measuring means, an n-th (where n is the integer 1 or 2) measuring means, or an m-th (where m is the integer 1 or 2 not equal to n) measuring means. The second measurement unit 11-2 corresponds to an example of a first measuring means, a second measuring means, an n-th measuring means, or an m-th measuring means. The response time calculation unit 12C corresponds to an example of a response time calculating means. The first response time calculation unit 12-1 corresponds to an example of a first response time calculating means, a second response time calculating means, an n-th response time calculating means, or an m-th response time calculating means. The second response time calculation unit 12-2 corresponds to an example of a first response time calculating means, a second response time calculating means, an n-th response time calculating means, or an m-th response time calculating means. The medium DB 13C corresponds to an example of a medium storing means. The distance calculation unit 14C corresponds to an example of a distance calculating means. The distance information generation unit 15C corresponds to an example of a distance information generating means. The medium velocity calculation unit 18 corresponds to an example of a medium velocity calculating means.

The distance measuring device 1C, in addition to the features in the second embodiment, calculates the distance by also calculating the medium velocity.

The first measurement unit 11-1 transmits a probe packet P₁ to the probe target 4 and receives a response packet R₁ from the probe target 4. The first measurement unit 11-1 acquires a first transmission timing Tp₁ at which the probe packet P₁ was transmitted, and a first reception timing Tr₁ at which the response packet R₁ was received. The first measurement unit 11-1 transmits a probe packet P₁₁ to the second measurement unit 11-2 and receives a response packet R₁₁ from the second measurement unit 11-2. The first measurement unit 11-1 acquires a third transmission timing Tp₁₁ at which the probe packet P₁₁ was transmitted, and a third reception timing Tr₁₁ at which the response packet R₁₁ was received.

The second measurement unit 11-2 transmits a probe packet P₂ to the probe target 4 and receives a response packet R₂ from the probe target 4. The second measurement unit 11-2 acquires a second transmission timing Tp₂ at which the probe packet P₂ was transmitted, and a second reception timing Tr₂ at which the response packet R₂ was received. The second measurement unit 11-2 transmits a probe packet P₂₁ to the first measurement unit 11-1 and receives a response packet R₂₁ from the first measurement unit 11-1. The second measurement unit 11-2 acquires a fourth transmission timing Tp₂₁ at which the probe packet P₂₁ was transmitted, and a fourth reception timing Tr₂₁ at which the response packet R₂₁ was received.

The first response time calculation unit 12-1 uses the first transmission timing Tp₁, the first reception timing Tr₁, and Expression (3) to calculate a first response time RTT₁. The first response time calculation unit 12-1 stores the calculated first response time RTT₁ in the measurement results DB 16C. The first response time calculation unit 12-1 uses the third transmission timing Tp₁₁, the third reception timing Tr₁₁, and the following Expression (7) to calculate a third response time RTT₁₁. The first response time calculation unit 12-1 stores the calculated third response time RTT₁₁ in the measurement results DB 16C.

$$\begin{matrix}[ Mathematical Expression 7 ] & \\ R T {T}_{11} = {Tr}_{11} - {Tp}_{11} & ( 7 )\end{matrix}$$

The second response time calculation unit 12-2 uses the second transmission timing Tp₂, the second reception timing Tr₂, and Expression (4) to calculate a second response time RTT₂. The second response time calculation unit 12-2 stores the calculated second response time RTT₂ in the measurement results DB 16. The second response time calculation unit 12-2 uses the fourth transmission timing Tp₂₁, the fourth reception timing Tr₂₁, and the following Expression (8) to calculate a fourth response time RTT₂₁. The second response time calculation unit 12-2 stores the calculated fourth response time RTT₂₁ in the measurement results DB 16C.

$$\begin{matrix}[ Mathematical Expression 8 ] & \\ R T {T}_{21} = {Tr}_{21} - {Tp}_{21} & ( 8 )\end{matrix}$$

The medium velocity calculation unit 18 acquires, from the measurement results DB 16C, measurement results for the response time of a probe packet between the first measurement unit 11-1 and the second measurement unit 11-2. The medium velocity calculation unit 18 calculates the physical distance D between the measurement units in the case in which the positions of the measurement units (the first measurement unit 11-1 and the second measurement unit 11-2) are stored in the measuring device DB 17C. The medium velocity calculation unit 18 calculates the medium velocity Vm based on the calculated physical distance D and the response time between the first measurement unit 11-1 and the second measurement unit 11-2. The distance calculation method and the medium velocity calculation method will be explained below.

The distance calculation unit 14C acquires, from the medium DB 13C, a first medium velocity Vm₁ of the transmission medium between the first measurement unit 11-1 and the second measurement unit 11-2 that has been calculated. The distance calculation unit 14C acquires, from the medium DB 13C, a second medium velocity Vm₂ of the transmission medium between the second measurement unit 11-2 and the first measurement unit 11-1 that has been calculated. The distance calculation unit 14C calculates the first distance₁ and the second distance₂ by substituting Vm₁ for Vm in Expression (5) and substituting Vm₂ for Vm in Expression (6). The first distance is the distance between the first measurement unit 11-1 and the probe target 4. The second distance₂ is the distance between the second measurement unit 11-2 and the probe target 4.

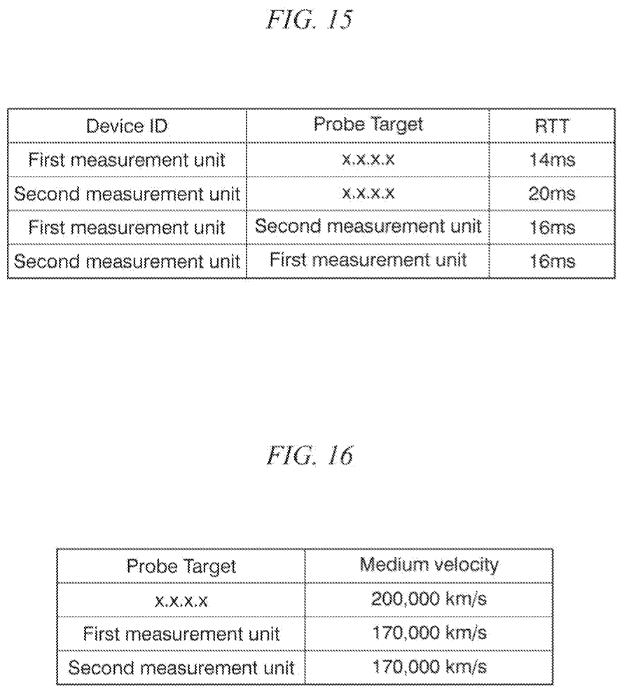

FIG. 15 is a diagram indicating examples of information stored in the measurement results DB according to the present embodiment. As shown in FIG. 15, the measurement results DB 16C stores, for example, information (e.g., IP addresses) indicating probe targets and response times RTT in association with identification information for n-th measurement units 11-n. According to FIG. 15, for example, the first response time RTT₁ measured by the first measurement unit 11-1 transmitting a probe packet to the probe target 4 is 14 ms, and the second response time RTT₂ measured by the second measurement unit 11-2 transmitting a probe packet to the probe target 4 is 20 ms. Furthermore, the measurement results DB 16C stores a third response time RTT₁₁ (16 ms) measured by the first measurement unit 11-1 transmitting a probe packet to the second measurement unit 11-2, and a fourth response time RTT₂₁ (16 ms) measured by the second measurement unit 11-2 transmitting a probe packet to the first measurement unit 11-1.

FIG. 16 is a diagram indicating examples of information stored in the medium DB according to the present embodiment. As shown in FIG. 16, the medium DB 13C stores the medium velocity for the case in which the probe target is the probe target 4, the position of which is known, the medium velocity for the case in which the probe target is the first measurement unit 11-1, and the medium velocity for the case in which the probe target is the second measurement unit 11-2.

The medium velocity in the transmission medium used for transmission between the second measurement unit 11-2 and the first measurement unit 11-1, and the medium velocity in the transmission medium used for transmission between the first measurement unit 11-1 and the second measurement unit 11-2 are calculated and stored in the medium DB 13C. In the example in FIG. 16, the medium velocities for probe targets 4 at unknown positions are not stored.

Next, an example of the processing procedure in the distance measuring device 1C will be explained.

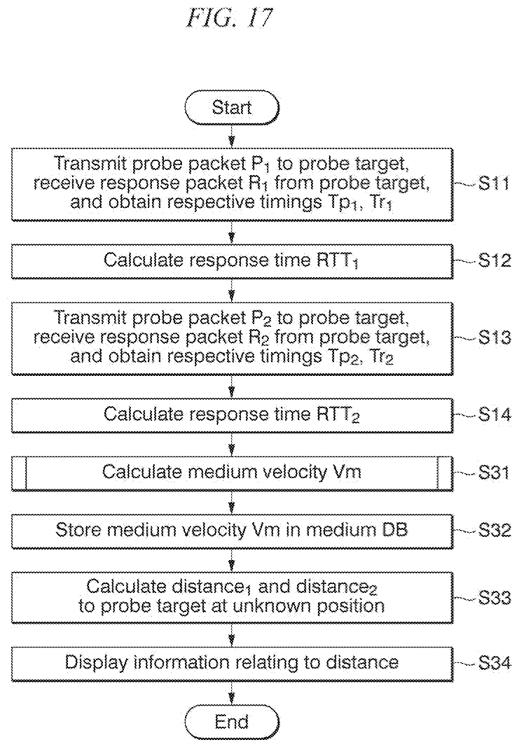

FIG. 17 is a flow chart of the processing procedure in the distance measuring device according to the present embodiment.

(Step S11) The first measurement unit 11-1 transmits a probe packet P₁ to the probe target 4 at an unknown position, and receives a response packet R₁ from the probe target 4. The first measurement unit 11-1 acquires a first transmission timing Tp₁ at which the probe packet P₁ was transmitted and a first reception timing Tr₁ at which the response packet R was received.

(Step S12) The first response time calculation unit 12-1 uses the first transmission timing Tp₁, the first reception timing Tr₁, and Expression (3) to calculate the first response time RTT₁.

(Step S13) The second measurement unit 11-2 transmits a probe packet P₂ to the probe target 4 at an unknown position, and receives a response packet R₂ from the probe target 4. The second measurement unit 11-2 acquires a second transmission timing Tp₂ at which the probe packet P₂ was transmitted and a second reception timing Tr₂ at which the response packet R₂ was received.

(Step S14) The second response time calculation unit 12-2 uses the second transmission timing Tp₂, the second reception timing Tr₂, and Expression (4) to calculate the second response time RTT₂.

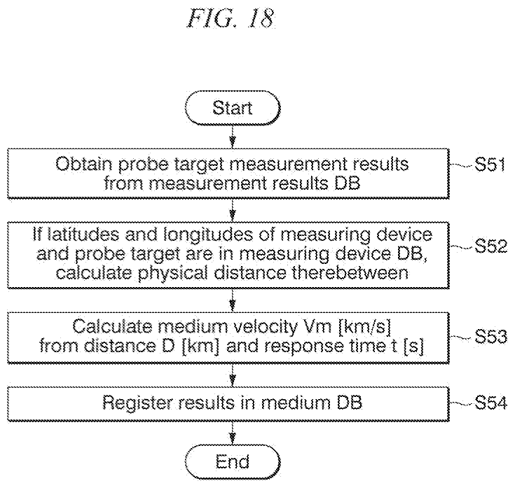

(Step S31) The medium velocity calculation unit 18 calculates the medium velocity Vm. The method and procedure for calculating the medium velocity Vm will be explained below using FIG. 18.

(Step S32) The medium velocity calculation unit 18 stores the calculated medium velocity Vm in the medium DB 13C. The medium velocity calculation unit 18 calculates the medium velocity Vm between the first measurement unit 11-1 and the second measurement unit 11-2, and stores it in the medium DB 13C.

(Step S33) The first measurement unit 11-1 acquires the first response time RTT₁ to the probe target 4 at an unknown position, calculated in steps S11 and S12. The second measurement unit 11-2 acquires the second response time RTT₂ to the probe target 4 at an unknown position, calculated in steps S13 and S14.

The distance calculation unit 14C acquires, from the medium DB 13C, the medium velocity Vm to and from the first measurement unit 11-1 and the medium velocity Vm to and from the second measurement unit 11-2 that was calculated in step S31. The distance calculation unit 14C uses Expression (5) to calculate the first distance₁ between the first measurement unit 11-1 and the probe target 4 at an unknown position. The distance calculation unit 14C uses Expression (6) to calculate the second distance₂ between the second measurement unit 11-2 and the probe target 4 at an unknown position.

In this way, the distance calculation unit 14C calculates the first distance to the probe target 4 based on the medium velocity Vm₁ between the first measurement unit 11-1 and the second measurement unit 11-2, and the first response time RTT₁ between the first measurement unit 11-1 and the probe target 4 at an unknown position. The distance calculation unit 14C calculates the second distance₂ to the probe target 4 based on the medium velocity Vm₂ between the second measurement unit 11-2 and the first measurement unit 11-1, and the second response time RTT₂ between the second measurement unit 11-2 and the probe target 4 at an unknown position.

For example, the medium velocity Vm between the first measurement unit 11-1 and the probe target 4 can be assumed to not deviate largely from the medium velocities Vm₁ and Vm₂ between the first measurement unit 11-1 and the second measurement unit 11-2. For this reason, in the case in which the medium velocity Vm between the first measurement unit 11-1 and the probe target 4 is unclear, the distance to the probe target 4 can be calculated with higher accuracy by using the medium velocities Vm₁, Vm₂ between the first measurement unit 11-1 and the second measurement unit 11-2. The same applies to the calculation of the distance between the second measurement unit 11-2 and the probe target 4.

(Step S34) The distance information generation unit 15C generates information relating to the distance using the first distance₁ and the second distance₂ that have been calculated, and presents the generated information relating to distance on the display device 3.

Next, the method and procedure for calculating distance in the medium velocity calculation unit 18 will be explained.

FIG. 18 is a flow chart of the distance calculation procedure in the medium velocity calculation unit according to the present embodiment.

(Step S51) The medium velocity calculation unit 18 acquires, from the measurement results DB 16C, measurement results obtained by transmitting and measuring probe packets.

The medium velocity calculation unit 18 acquires the third response time RTT₁₁ measured by the first measurement unit 11-1 transmitting a probe packet to the second measurement unit 11-2, and acquires the fourth response time RTT₂₁ measured by the second measurement unit 11-2 transmitting a probe packet to the first measurement unit 11-1.

(Step S52) In the case in which positions (latitude and longitude) between the measurement units (the first measurement unit 11-1 and the second measurement unit 11-2) are stored in the measuring device DB 17C, the medium velocity calculation unit 18 uses the following Expression (9) to calculate the physical distance D between the measurement units and the probe target. The medium velocity calculation unit 18 calculates the physical distance D between the measurement units based on position information of the respective measurement units, the positions of which are known.

$$\begin{matrix}[ Mathematical Expression 9 ] & \\ D = \sqrt{{( Dy \cdot M )}^{2} + {( Dx \cdot N \cdot cos P )}^{2}} & ( 9 )\end{matrix}$$

In Expression (9), Dx is the longitude (radians) between two points that are between the measurement units. Dy is the latitude (radians) between the two points that are between the measurement units. P is the average value of the latitude between the two points between the measurement units. M is the meridian radius of curvature, given by the following Expression (10). In Expression (10), W is given by the following Expression (11). In Expression (9), N is the prime vertical radius of curvature, given by Expression (12). Additionally, in Expression (10), E is the eccentricity, given by Expression (13). In Expression (13), Rx is the semi-major axis (equatorial radius) and Ry is the semi-minor axis (polar radius).

$$\begin{matrix}[ Mathematical Expression 10 ] & \\ M = \frac{R x ( 1 - {E}^{2} )}{{W}^{3}} & ( 10 )\end{matrix}$$

$$\begin{matrix}[ Mathematical Expression 11 ] & \\ W = \sqrt{1 - {E}^{2} \cdot {sin}^{2} P} & ( 11 )\end{matrix}$$

$$\begin{matrix}[ Mathematical Expression 12 ] & \\ N = \frac{R x}{W} & ( 12 )\end{matrix}$$

$$\begin{matrix}[ Mathematical Expression 13 ] & \\ E = \sqrt{\frac{R {x}^{2} - R {y}^{2}}{R {x}^{2}}} & ( 13 )\end{matrix}$$

(Step S53) The medium velocity calculation unit 18 uses the following Expression (14) to calculate the medium velocities Vm (km/s) based on distances D (km) and response times t(s).

The medium velocity calculation unit 18 calculates the medium velocity Vm₁ between the first measurement unit 11-1 and the second measurement unit 11-2 based on the physical distance D between the measurement units (between the first measurement unit 11-1 and the second measurement unit 11-2) and the third response time RTT₁₁ acquired in step S51. The medium velocity calculation unit 18 calculates the medium velocity Vm₂ between the first measurement unit 11-1 and the second measurement unit 11-2 based on the physical distance D between the measurement units and the fourth response time RTT₂₁ acquired in step S51.

$$\begin{matrix}[ Mathematical Expression 14 ] & \\ Vm = \frac{2 D}{t} & ( 14 )\end{matrix}$$

(Step S54) The medium velocity calculation unit 18 stores the calculated medium velocities Vm in the medium DB 13C. The medium velocity calculation unit 18 stores the medium velocities Vm between the first measurement unit 11-1 and the second measurement unit 11-2 in the medium DB 13C.

The semi-major axis and the semi-minor axis differ depending on the geodetic system (Bessel, GRS80, WGS84). For this reason, the medium velocity calculation unit 18 uses values in the same geodetic system as the semi-major axis and the semi-minor axis.

In the example mentioned above, an example in which the medium velocity between the first measurement unit 11-1 and the second measurement unit 11-2 is calculated. However, the disclosure is not limited thereto. It is sufficient for there to be one or more medium velocities that are calculated. Furthermore, in step S33, the distance calculation unit 14C may use at least one medium velocity stored in the medium DB 13C to calculate the distance to a probe target at an unknown position.

Thus, the distance calculation unit 14C calculates the distance to a probe target based on the response time of a probe packet to the probe target 4 by using the medium velocity on a transmission path to and from the device different from the probe target 4. The distance calculation unit 14C may calculate the distance to a probe target at an unknown position by using the medium velocity to and from multiple devices different from the probe target 4.

The information presented on the display device 3 is, for example, similar to that in FIG. 12 and FIG. 13.

As described above, in the present embodiment, two measurement units (the first measurement unit 11-1 and the second measurement unit 11-2) were used to measure response times and to further measure the medium velocity.

Thus, according to the present embodiment, the distance from a communication counterpart can be measured. According to the present embodiment, the medium velocities are measured. Thus, in addition to the effects of the second embodiment, distances can be more accurately calculated.

The medium velocity to and from the device different from the probe target, calculated based on the response time measured to and from said device and the physical distance between measurement units whose positions are known, is used to calculate the distance to the probe target at an unknown position. By using actual measurement values, distances can be accurately calculated.

### Fourth Embodiment

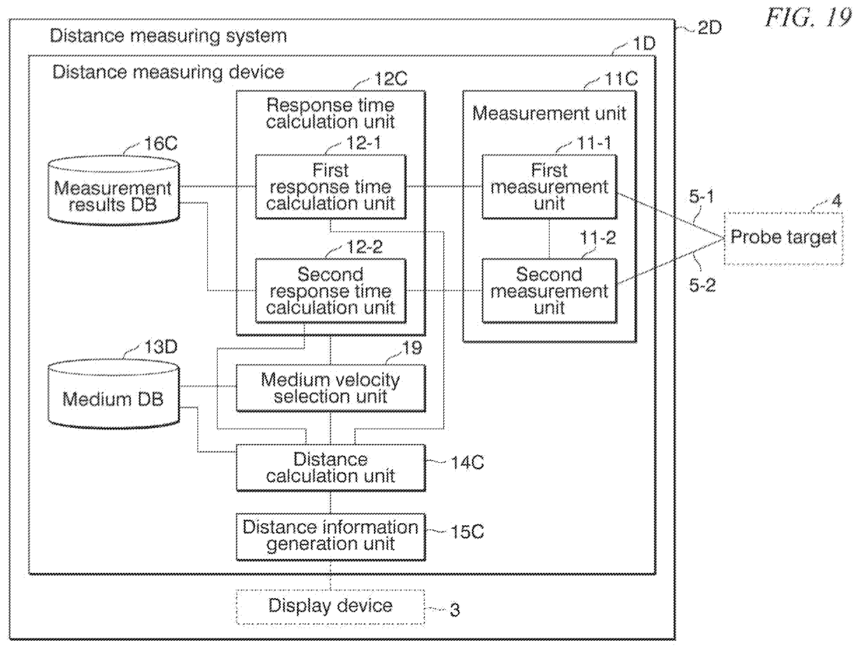

FIG. 19 is a diagram illustrating a configuration example of a distance measuring system according to the present embodiment. As shown in FIG. 19, the distance measuring system 2D is provided with a distance measuring device 1D and a display device 3. The distance measuring device 1D is provided with a measurement unit 11C, a response time calculation unit 12C, a medium DB 13D, a distance calculation unit 14C, a distance information generation unit 15C, a measurement results DB 16C, and a medium velocity selection unit 19.

The measurement unit 11C is provided with a first measurement unit 11-1 and a second measurement unit 11-2.

The response time calculation unit 12C is provided with a first response time calculation unit 12-1 and a second response time calculation unit 12-2.

The measurement unit 11C corresponds to an example of a measuring means. The first measurement unit 11-1 corresponds to an example of a first measuring means. The second measurement unit 11-2 corresponds to an example of a second measuring means. The response time calculation unit 12C corresponds to an example of a response time calculating means. The first response time calculation unit 12-1 corresponds to an example of a first response time calculating means. The second response time calculation unit 12-2 corresponds to an example of a second response time calculating means. The medium DB 13D corresponds to an example of a medium storing means. The distance calculation unit 14C corresponds to an example of a distance calculating means. The distance information generation unit 15C corresponds to an example of a distance information generating means. The medium velocity selection unit 19 corresponds to an example of a medium velocity selecting means.

In the case in which a medium velocity relating to the probe target 4 is stored in the medium DB 13D, the distance measuring device 1D calculates the distance by using the medium velocity of the probe target 4 stored in the medium DB 13D. In the case in which a medium velocity relating to the probe target 4 is not stored in the medium DB 13D, the distance measuring device 1D calculates the distance by using the medium velocity of another probe target stored in the medium DB 13D.

The medium DB 13D stores, for example, medium velocities calculated based on response times measured when the first measurement unit 11-1 transmitted probe packets to other probe targets. The medium DB 13D stores, for example, medium velocities calculated based on response times measured when the second measurement unit 11-2 transmitted probe packets to other probe targets.

In the case in which the medium velocity relating to the probe target 4 is stored in the medium DB 13D, the medium velocity selection unit 19 calculates the distance by using the medium velocity of the probe target stored in the medium DB 13D. In the case in which the medium velocity relating to the probe target 4 is not stored in the medium DB 13D, the medium velocity selection unit 19 calculates the distance by using the medium velocity of another probe target stored in the medium DB 13D.

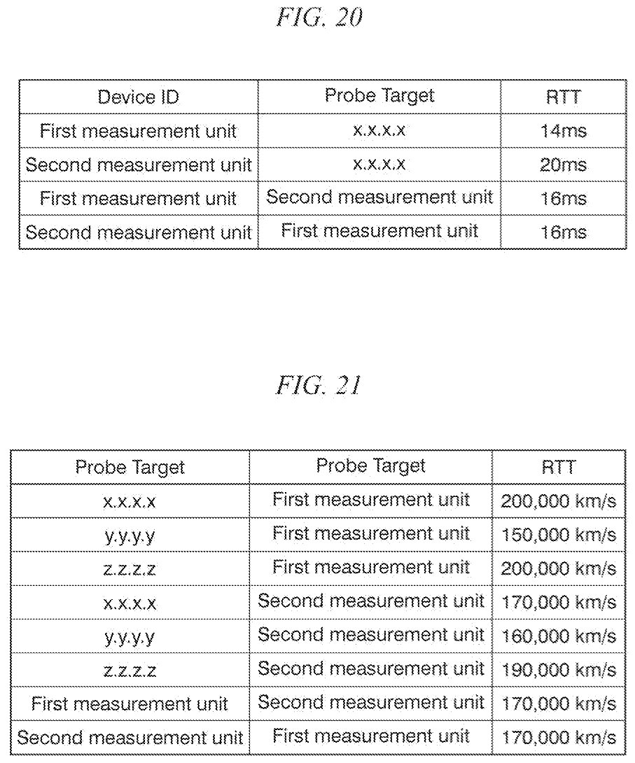

FIG. 20 is a diagram indicating examples of information stored in the measurement results DB according to the present embodiment. As shown in FIG. 20, the measurement results DB 16C stores a first response time measured by the first measurement unit 11-1 with respect to the probe target 4, and a first response time measured by the second measurement unit 11-2 with respect to the probe target 4. The measurement results DB 16C stores a third response time measured by the first measurement unit 11-1 with respect to the second measurement unit 11-2, and a fourth response time measured by the second measurement unit 11-2 with respect to the first measurement unit 11-1.

FIG. 21 is a diagram indicating examples of information stored in the medium DB according to the present embodiment. As shown in FIG. 21, the medium DB 13D respectively stores medium velocities obtained by the first measurement unit 11-1 probing multiple other probe targets. The medium DB 13D stores medium velocities obtained by the second measurement unit 11-2 probing other probe targets. The medium DB 13D stores a medium velocity based on the results of the first measurement unit 11-1 probing the second measurement unit 11-2. The medium DB 13D stores a medium velocity based on the results of the second measurement unit 11-2 probing the first measurement unit 11-1.

Next, an example of the processing procedure in the distance measuring device 1D will be explained.

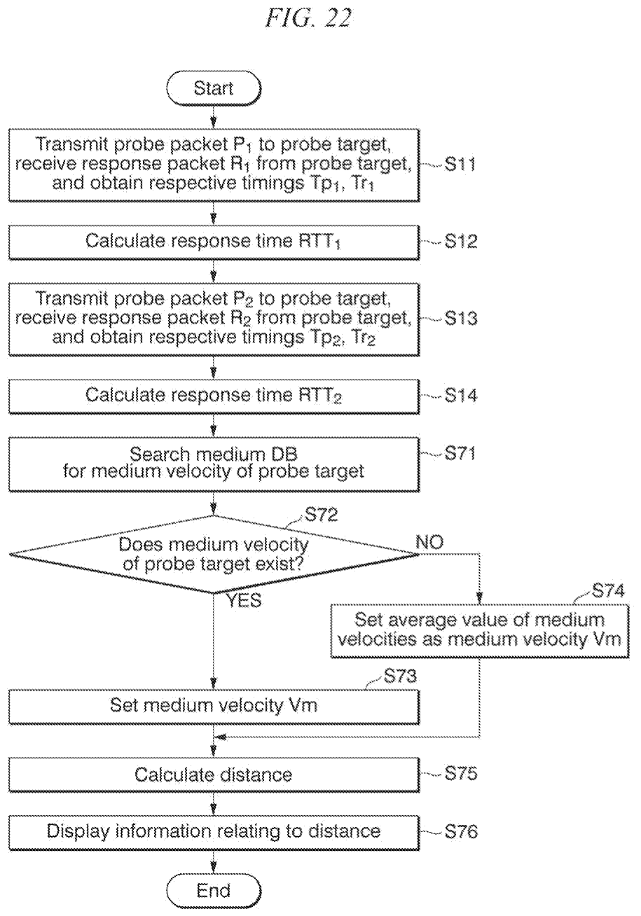

FIG. 22 is a flow chart of the processing procedure in the distance measuring device according to the present embodiment.

(Step S11) The first measurement unit 11-1 transmits a probe packet P₁ to the probe target 4 and receives a response packet R₁ from the probe target 4. The first measurement unit 11-1 acquires a transmission timing Tp₁ at which the probe packet P₁ was transmitted and a reception timing Tr₁ at which the response packet R was received.

(Step S12) The first response time calculation unit 12-1 uses the first transmission timing Tp₁, the first reception timing Tr₁, and Expression (3) to calculate the first response time RTT₁.

(Step S13) The second measurement unit 11-2 transmits a probe packet P₂ to the probe target 4 and receives a response packet R₂ from the probe target 4. The second measurement unit 11-2 acquires a transmission timing Tp₂ at which the probe packet P₂ was transmitted and a reception timing Tr₂ at which the response packet R₂ was received.

(Step S14) The second response time calculation unit 12-2 uses the second transmission timing Tp₂, the second reception timing Tr₂, and Expression (4) to calculate the second response time RTT₂.

(Step S71) The medium velocity selection unit 19 searches the medium DB 13D for the medium velocity between the measurement unit (the first measurement unit 11-1 or the second measurement unit 11-2) and the probe target 4.

(Step S72) The medium velocity selection unit 19 determines whether or not a medium velocity relating to the measurement unit (the first measurement unit 11-1 or the second measurement unit 11-2) and the probe target 4 was able to be acquired from the medium DB 13D. In the case in which it is determined that the medium velocity was able to be acquired from the medium DB 13D (step S72; YES), the medium velocity selection unit 19 advances to step S73. In the case in which it is determined that the medium velocity was not able to be acquired from the medium DB 13D (step S72; NO), the medium velocity selection unit 19 advances to step S74.

(Step S73) The medium velocity selection unit 19 sets the medium velocity for the first measurement unit 11-1 acquired from the medium DB 13D as the first medium velocity Vm, and sets the medium velocity for the second measurement unit 11-2 acquired from the medium DB 13D as the second medium velocity Vm. After this process, the medium velocity selection unit 19 advances to step S75.

(Step S74) The medium velocity selection unit 19 calculates the average value of all medium velocities stored in the medium DB 13D and sets the calculated average value as the medium velocity Vm. The medium velocity selection unit 19 may calculate the average value of all medium velocities for the transmission paths between the first measurement unit 11-1 and other targets stored in the medium DB 13D, and may set this calculated average value as a first medium velocity Vm. The medium velocity selection unit 19 may calculate the average value of all medium velocities for the transmission paths between the second measurement unit 11-2 and other targets stored in the medium DB 13D, and may set this calculated average value as a second medium velocity Vm. After this process, the medium velocity selection unit 19 advances to step S75.

(Step S75) The distance calculation unit 14C uses a medium velocity that was able to be acquired from medium DB 13D or the average value of the medium velocities, and Expression (5), to calculate a first distance between the first measurement unit 11-1 and the probe target 4. The distance calculation unit 14C uses a medium velocity that was able to be acquired from medium DB 13D or the average value of the medium velocities, and Expression (6), to calculate a second distance₂ between the second measurement unit 11-2 and the probe target 4.

The distance calculation unit 14C may calculate the first distance₁ based, for example, on an average value, a median value, etc. of the respective medium velocities between the first measurement unit 11-1 and all other targets stored in the medium DB 13D. Alternatively, the distance calculation unit 14C may calculate the first distance₁ based on the medium velocity between the first measurement unit 11-1 and some of the other targets stored in the medium DB 13D. The same applies to the calculation of the second distance₂.

(Step S76) The distance information generation unit 15C generates information relating to the distance by using the first distance, and the second distance₂ that have been calculated, and presents the generated information relating to the distance on the display device 3.

The information presented on the display device 3 is similar, for example, to those in FIG. 12 and FIG. 13.

As described above, in the present embodiment, response times are measured using two measurement units (the first measurement unit 11-1 and the second measurement unit 11-2), and medium velocities are further selected from the medium DB 13D or calculated.

Thus, according to the present embodiment, the distance from a communication counterpart can be measured. According to the embodiment, the medium velocities stored in the medium DB 13D are used in different manners. Thus, in addition to the effects of the second embodiment, distances can be more accurately calculated. By using the medium velocities on transmission paths to and from other targets that are assumed to have similar medium velocities, distances can be accurately calculated even when the medium velocity to and from a probe target is not being held.

### Fifth Embodiment

In the respective embodiments described above, the measurement unit 11 (or the first measurement unit 11-1 and the second measurement unit 11-2) may refrain from transmitting a probe packet to the probe target 4 for distance measurement. In this case, the distance measuring device 1 (or 1A, 1B, 1C or 1D) may, for example, observe a packet P transmitted from a first device to a second device, and may observe a packet R, responding to the packet P, transmitted from the second device to the first device. Furthermore, the distance measuring device 1 (or 1A, 1B, 1C or 1D) may calculate the response time by using the transmission timing at which packet P was observed and the reception timing at which the packet R was observed. Hereinafter, an example in which the present embodiment has been applied to the distance measuring device 1A of the first embodiment will be explained.

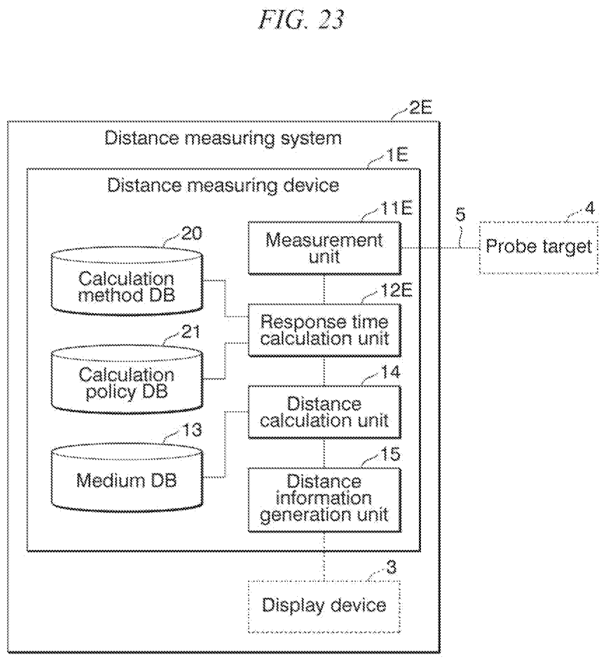

FIG. 23 is a diagram illustrating a configuration example of a distance measuring system according to the present embodiment. As shown in FIG. 23, the distance measuring system 2E is provided with a distance measuring device 1E and a display device 3. The distance measuring device 1E is provided with a measurement unit 11E, a response time calculation unit 12E, a medium DB 13, a distance calculation unit 14, a distance information generation unit 15, a calculation method DB 20, and a calculation policy DB 21. The measurement unit 11E corresponds to an example of a measuring means. The response time calculation unit 12E corresponds to an example of a response time calculating means. The medium DB 13 corresponds to an example of a medium storing means. The distance calculation unit 14 corresponds to an example of a distance calculating means. The distance information generation unit 15 corresponds to an example of a distance information generating means.

The calculation method DB 20 is a database that stores calculation methods to be used when the response time calculation unit 12E calculates response times.

The calculation policy DB 21 is a database that stores calculation policies to be used when the response time calculation unit 12E calculates response times.

The response time calculation unit 12E selects calculatable items and calculates response times by employing the smallest numerical value among the calculation policies. For example, the response time calculation unit 12E calculates the response times based on calculation methods stored in the calculation method DB 20 in accordance with calculation policies stored in the calculation policy DB 21.

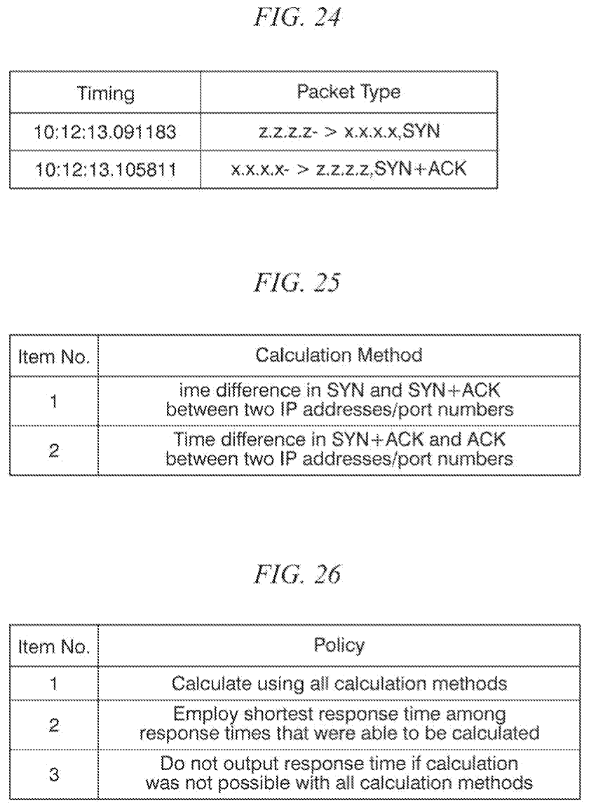

FIG. 24 is a diagram illustrating examples of observed packets. In the example in FIG. 24, it is observed that a sync signal (SYN) was transmitted, as packets, from a first device z.z.z.z (IP address) to a second device x.x.x.x (IP address) at the timing 10:12:13.091183, and that a sync signal (SYN) and an ack signal (ACK) were transmitted, as packets, from the second device x.x.x.x (IP address) to the first device z.z.z.z at the timing 10:12:13.105811. Such packets are observed by the measurement unit 11E.

FIG. 25 is a diagram indicating examples of information stored in the calculation method DB according to the present embodiment. As shown in FIG. 25, the calculation method DB 20 stores calculation methods in association with respective item numbers, which are item numberings. In the example in FIG. 25, “Time difference in SYN and SYN+ACK between two IP addresses/port numbers” is associated with item number 1, and “Time difference in SYN+AC and ACK between two IP addresses/port numbers” is associated with item number 2. The calculation methods indicated in FIG. 25 are merely an example, and the disclosure is not limited thereto.

For example, according to the method of item number 1, a response time is calculated based on the time difference between the timing at which the sync signal (SYN) was transmitted from the first device to the second device, and the timing at which the sync signal (SYN) and the ack signal (ACK) were transmitted from the second device to the first device.

FIG. 26 is a diagram indicating examples of information stored in the calculation policy DB according to the present embodiment. As shown in FIG. 26, the calculation policy DB 21 stores calculation policies in association with respective item numbers, which are item numberings. In the example in FIG. 26, “Calculate using all calculation methods” is associated with item number 1, “Employ shortest response time among response times that were able to be calculated” is associated with item number 2, and “Do not output response time if calculation was not possible with all calculation methods” is associated with item number 3. The calculation policies indicated in FIG. 26 are merely an example, and the disclosure is not limited thereto.

Thus, the response time calculation unit 12E references the calculation method DB 20 and the calculation policy DB 21. The response time calculation unit 12E calculates response times based on calculation methods stored in the calculation method DB 20 in accordance with calculation policies stored in the calculation policy DB 21.

An example of the case in which the calculation policies of item number 1 to item number 3 are associated in the calculation policy DB 21, as shown in FIG. 26, will be explained. In this case, according to the calculation policy of item number 1, the response time calculation unit 12E calculates the respective response times based on each of the calculation methods stored in the calculation method DB 20. Next, according to the calculation policy of item number 2, the response time calculation unit 12E employs the response time with the smallest value among the response times calculated based on each of the calculation methods. At this time, according to the calculation policy of item number 3, the response time calculation unit 12E does not output a response time in the case in which response times cannot be calculated with all of the calculation methods.

The present embodiment is also applicable to the second embodiment to the fourth embodiment.

Thus, in the present embodiment, packet information is transmitted, and the response time is calculated by using the transmission and reception timings of a response packet signal corresponding to the transmitted packet information. Additionally, in the present embodiment, response time calculation methods and calculation policies are stored in a database. More appropriate response times can be calculated by setting the response time calculation policies and the response time calculation methods in accordance with the environment and the conditions.

Thus, according to the present embodiment, the distance from a communication counterpart can be measured with higher accuracy. According to the present embodiment, distances can be calculated without the measurement unit 11E transmitting probe packets.

### Sixth Embodiment

In the present embodiment, when plotting the positional ranges, etc. of probe targets on a two-dimensional plane, as shown in FIG. 13, in addition to calculating the medium velocity as in the third embodiment, position information based on terrain information is calculated and displayed.

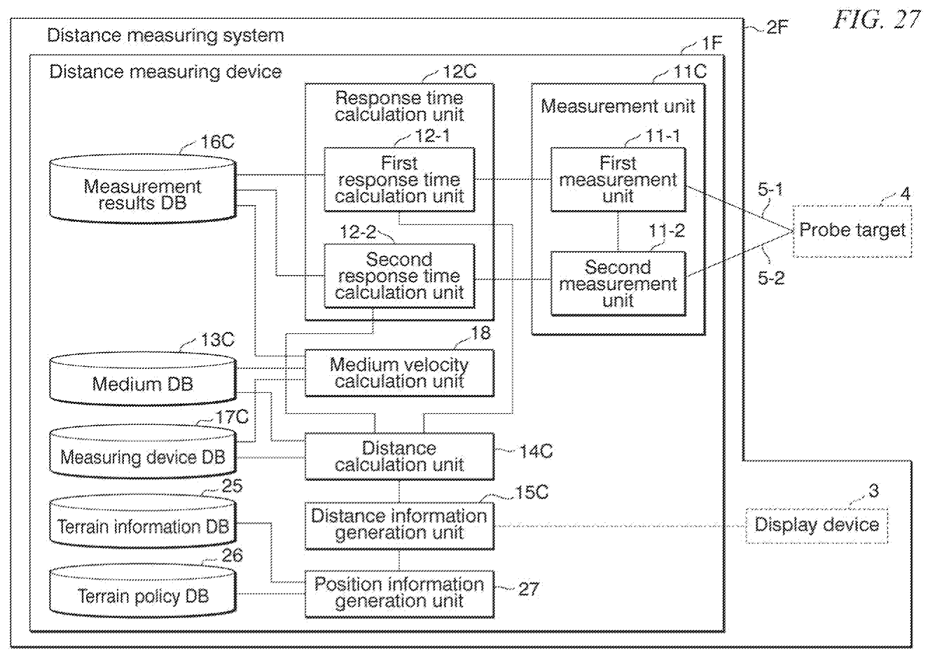

FIG. 27 is a diagram illustrating a configuration example of a distance measuring system according to the present embodiment. As shown in FIG. 27, the distance measuring system 2F is provided with a distance measuring device 1F and a display device 3. The distance measuring device 1F is provided with a measurement unit 11C, a response time calculation unit 12C, a medium DB 13C, a distance calculation unit 14C, a distance information generation unit 15C, a measurement results DB 16C, a measuring device DB 17C, a medium velocity calculation unit 18, a terrain information DB 25, a terrain policy DB 26, and a position information generation unit 27.

The measurement unit 11C is provided with a first measurement unit 11-1 and a second measurement unit 11-2. The measurement unit 11C may be provided with three or more measurement units.

The response time calculation unit 12C is provided with a first response time calculation unit 12-1 and a second response time calculation unit 12-2.

The measurement unit 11C corresponds to an example of a measuring means. The first measurement unit 11-1 corresponds to an example of a first measuring means, a second measuring means, an n-th (where n is the integer 1 or 2) measuring means, or an m-th (where m is the integer 1 or 2 not equal to n) measuring means. The second measurement unit 11-2 corresponds to an example of a first measuring means, a second measuring means, an n-th measuring means, or an m-th measuring means. The response time calculation unit 12C corresponds to an example of a response time calculating means. The first response time calculation unit 12-1 corresponds to an example of a first response time calculating means, a second response time calculating means, an n-th response time calculating means, or an m-th response time calculating means. The second response time calculation unit 12-2 corresponds to an example of a first response time calculating means, a second response time calculating means, an n-th response time calculating means, or an m-th response time calculating means. The medium DB 13C corresponds to an example of a medium storing means. The distance calculation unit 14C corresponds to an example of a distance calculating means. The distance information generation unit 15C corresponds to an example of a distance information generating means. The medium velocity calculation unit 18 corresponds to an example of a medium velocity calculating means. The position information generation unit 27 corresponds to an example of a position information generating means.

The distance measuring device 1F, in addition to the features in the third embodiment, also uses information regarding terrain and terrain policy information to determine the position with the highest probability on a map.

The first measurement unit 11-1 transmits a probe packet P₁ to the probe target 4 and receives a response packet R₁ from the probe target 4. The first measurement unit 11-1 acquires a first transmission timing Tp₁ at which the probe packet P₁ was transmitted, and a first reception timing Tr₁ at which the response packet R₁ was received. The first measurement unit 11-1 transmits a probe packet P₁₁ to the second measurement unit 11-2 and receives a response packet R₁₁ from the second measurement unit 11-2. The first measurement unit 11-1 acquires a third transmission timing Tp₁₁ at which the probe packet P₁₁ was transmitted, and a third reception timing Tr₁₁ at which the response packet R₁₁ was received.

The second measurement unit 11-2 transmits a probe packet P₂ to the probe target 4 and receives a response packet R₂ from the probe target 4. The second measurement unit 11-2 acquires a second transmission timing Tp₂ at which the probe packet P₂ was transmitted, and a second reception timing Tr₂ at which the response packet R₂ was received. The second measurement unit 11-2 transmits a probe packet P₂₁ to the first measurement unit 11-1 and receives a response packet R₂₁ from the first measurement unit 11-1. The second measurement unit 11-2 acquires a fourth transmission timing Tp₂₁ at which the probe packet P₂₁ was transmitted, and a fourth reception timing Tr₂₁ at which the response packet R₂₁ was received.

The first response time calculation unit 12-1 uses the first transmission timing Tp₁, the first reception timing Tr₁, and Expression (3) to calculate a first response time RTT₁. The first response time calculation unit 12-1 stores the calculated first response time RTT₁ in the measurement results DB 16C. The first response time calculation unit 12-1 uses the third transmission timing Tp₁₁, the third reception timing Tr₁₁, and Expression (7) to calculate a third response time RTT₁₁. The first response time calculation unit 12-1 stores the calculated third response time RTT₁₁ in the measurement results DB 16C.

The second response time calculation unit 12-2 uses the second transmission timing Tp₂, the second reception timing Tr₂, and Expression (4) to calculate a second response time RTT₂. The second response time calculation unit 12-2 stores the calculated second response time RTT₂ in the measurement results DB 16C. The second response time calculation unit 12-2 uses the fourth transmission timing Tp₂₁, the fourth reception timing Tr₂₁, and Expression (8) to calculate a fourth response time RTT₂₁. The second response time calculation unit 12-2 stores the calculated fourth response time RTT₂₁ in the measurement results DB 16C.

The medium velocity calculation unit 18 acquires, from the measurement results DB 16C, measurement results for the probe target 4. In the case in which the positions of the measurement units (the first measurement unit 11-1 and the second measurement unit 11-2) and the position (latitude and longitude) of the probe target 4 are stored in the measuring device DB 17C, the medium velocity calculation unit 18 calculates the physical distance D between the measurement units and the probe target. The medium velocity calculation unit 18 calculates the medium velocities Vm based on the calculated physical distance D and the response time. The distance calculation method and the medium velocity calculation method will be explained below.

The distance calculation unit 14C acquires, from the medium DB 13C, a first medium velocity Vm₁ of the transmission medium for the first measurement unit 11-1 that has been calculated. The distance calculation unit 14C acquires, from the medium DB 13C, a second medium velocity Vm₂ of the transmission medium for the second measurement unit 11-2 that has been calculated. The distance calculation unit 14C calculates the first distance₁ and the second distance₂ by substituting Vm₁ for Vm in Expression (5) and substituting Vm₂ for Vm in Expression (6).

The terrain information DB 25 stores information regarding terrain. The information regarding terrain, for example, is associated with at least one of altitude, information indicating that there is a mountain, information indicating that there is a river, information indicating that there is a lake, information indicating that there is a sea, information indicating that there is an island, information indicating that there are fields, and information indicating that there is a forest, in accordance with the latitude and longitude. Thus, the terrain information DB 25 stores, for each position, information regarding the type of terrain at that position. The terrain information DB 25 may be connected to the distance measuring device 1F over a network, or may be located on a cloud.

The terrain policy DB 26 stores terrain policy information. The terrain policy information will be explained below. The terrain policy DB 26 may be connected to the distance measuring device 1F over a network, or may be located on a cloud.

The position information generation unit 27 generates position information by using distance information calculated by the distance calculation unit 14C, information regarding the terrain stored in the terrain information DB 25, and terrain policy information stored in the terrain policy DB 26. The position information will be explained below.

Next, examples of terrain policy information will be explained.

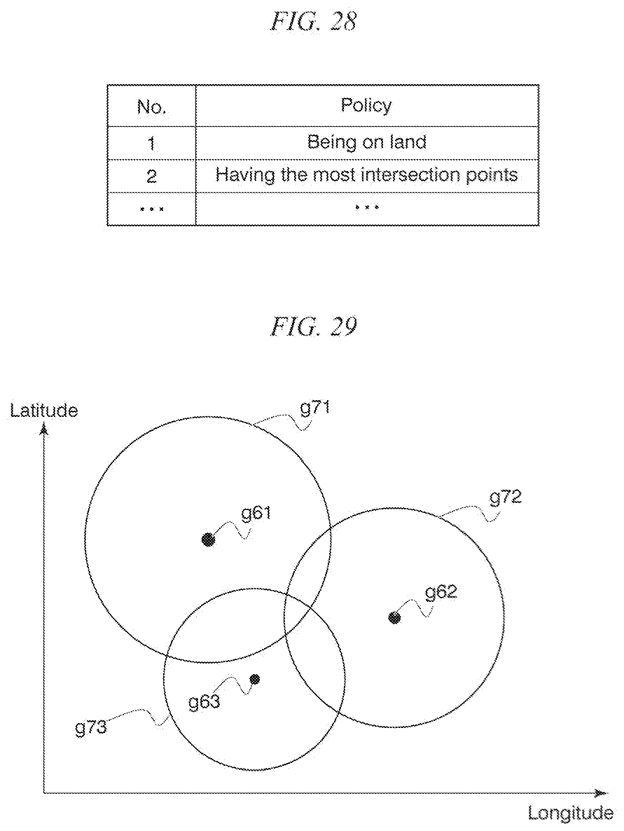

FIG. 28 is a diagram indicating examples of terrain policy information according to the present embodiment. As shown in FIG. 28, the terrain policy information includes conditions to be used when identifying positions, for example, “Being on land”, “Having the most intersection points”, etc. Additionally, land may include sea areas within a prescribed range (the range that can be reached by radio waves) from land. Thus, the terrain policy information includes selection conditions for selecting at least one candidate position from among multiple candidate positions for probe targets.

The position information generation unit 27 references the terrain policy DB 26 to acquire terrain policy information. According to the example in FIG. 28, “Being on land” and “Having the most intersection points” are stored as conditions for selecting candidate positions for the probe target.

In the case in which the measurement unit 11C is provided, for example, with three measurement units, as shown in FIG. 29, there are three points (point g61 to point g63) that are centers, and three circles (circle g71 to circle g73) centered at the points g61 to g63. Circle g71 to circle g73 are circles centered at the positions g61 to g63 of the respective measurement units and having the distances from the measurement units to the probe target as the radii. The points at which these three circles g71 to g73 intersect are intersection points. FIG. 29 is a diagram indicating an example of a plot in the case in which there are three measurement units.

Additionally, in the case in which the probe target uses a satellite link, there may be cases in which the position of the probe target is in the sea or the like. Thus, the terrain policy information may be used by being switched in accordance with the probe target, etc. The position information generation unit 27 may, for example, switch the terrain policy information that is used in accordance with whether or not a probe target is a terminal or a server. In the case in which a satellite is used, if the measurement time is, for example, 1000 (ms), the roundtrip time (e.g., 500 (ms)) between the satellite and a terrestrial base station may be subtracted from the 1000 (ms), and the distance and position range of the probe target can be estimated based on the remaining 500 (ms). Thus, in the case in which a satellite is included, the processing may be performed by excluding the distance between the satellite and a base station.

Next, an example of the processing procedure in the distance measuring device 1F will be explained.

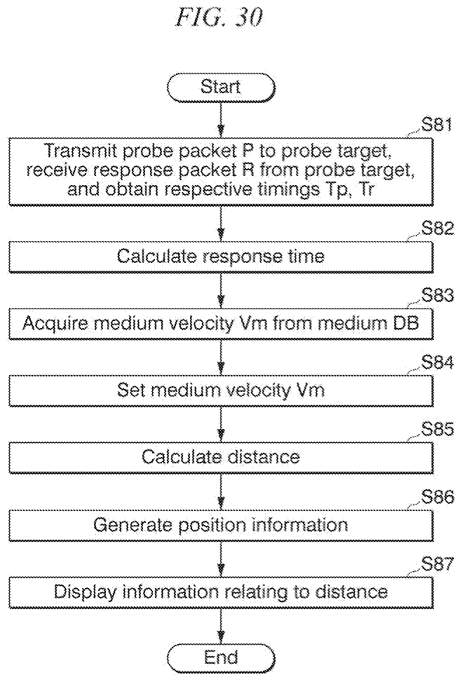

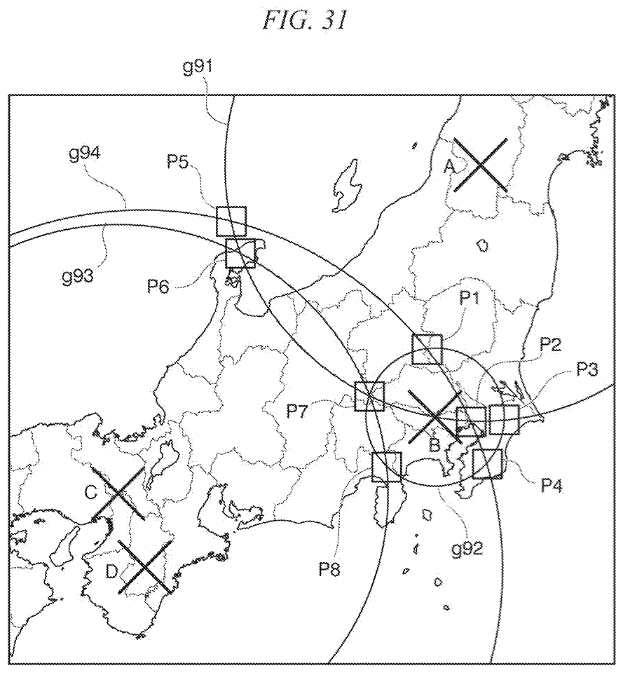

FIG. 30 is a flow chart of the processing procedure in the distance measuring device according to the present embodiment.

(Step S81) The measurement unit 11C transmits a probe packet P to the probe target 4 and receives a response packet R from the probe target 4. The measurement unit 11C acquires a transmission timing Tp at which the probe packet P was transmitted and a reception timing Tr at which the response packet R was received.

(Step S82) The response time calculation unit 12C uses the transmission timing Tp, the reception timing Tr, and Expression (1) to calculate the response time R.

(Step S83) The distance calculation unit 14C acquires the medium velocity Vm in the transmission medium between the distance measuring device 1F and the probe target 4 from the medium DB 13C.

(Step S84) The distance calculation unit 14C is set to the acquired medium velocity Vm.

(Step S85) The distance calculation unit 14C uses Expression (2) to calculate the distance between the distance measuring device 1F and the probe target 4.

(Step S86) The position information generation unit 27 generates position information by using the distance information calculated by the distance calculation unit 14C, the information regarding the terrain stored in the terrain information DB 25, and the terrain policy information stored in the terrain policy DB.

(Step S87) The distance information generation unit 15C generates position information regarding the position of the probe target calculated and generated by the distance calculation unit 14C and the position information generation unit 27, and presents the generated position information on the display device 3, for example, by using a map, etc., as shown in FIG. 31. The display example in FIG. 31 is merely an example, and the disclosure is not limited thereto.

For example, the position information generation unit 27 references the terrain information DB 25 and acquires terrain information corresponding to positions. The position information generation unit 27 references the terrain policy DB 26 to acquire terrain policy information, and generates position information reflecting the acquired terrain policy information.

Next, an example of calculation results will be explained.

FIG. 31 is a diagram indicating examples of results of measurements using four measurement units. The installation positions of the respective measurement units are A, B, C, and D in the diagram. The circle g91 indicates the distance range calculated using the first measurement unit. The circle g92 indicates the distance range calculated using the second measurement unit. The circle g93 indicates the distance range calculated using the third measurement unit. The circle g94 indicates the distance range calculated using the fourth measurement unit. The points P1 to P8 are intersection points between circles.

As shown in the example in FIG. 31, the positions of the intersection points P1, P2, P3, P4, P7, and P8 are on land, and the positions of the other intersection points P5 and P6 are in the sea or in areas near the sea. Furthermore, regarding the number of overlapping circles, there are two at the intersection points P1, P2, P3, P4, P5, P6, and P8, and three at the intersection point P7.

For example, in the case in which the terrain policy information “Being on land” and “Having the most intersection points” is used, the position that most satisfies the conditions indicated by the terrain policy information is the intersection point P7. The position information generation unit 27 calculates position information for the probe target based on the intersection point positions of circles indicating the distance ranges as described above, the numbers of intersection points, and the terrain policy information. Thus, the position information generation unit 27 uses not only distance information but also information regarding terrain and terrain policy information to determine the position with the highest probability on a map. The position information generation unit may represent the intersection point having the highest probability of being the position of the probe target among the multiple intersection points in a manner distinguishable from the other intersection points.

The position information generation unit 27 may, in addition to the calculated distance information, store information relating to terrain and terrain policy information, thereby allowing probe target position candidates to be more accurately narrowed.

In the examples indicated in FIG. 29 and FIG. 31, the position ranges may be provided with a prescribed width, as explained with reference to FIG. 13. Thus, in this embodiment, the intersection points may include a prescribed range of overlap.

When using multiple measurement units, the measurement units may be weighted. Thus, when measurements have been performed in the past, and for example, the accuracy of the distances calculated by the third measurement unit is worse than that of the other measurement units, the position information generation unit 27 may set the weighting of the third measurement unit to be zero. Furthermore, the position information generation unit 27 may ignore intersection points with this third measurement unit. The conditions relating to such weightings may be set in the terrain policy information.

In the case in which, as a result of having calculated distances, the width of variation in multiple measurement values, i.e., the jitter width, is large, this indicates that the accuracy is poor. In such cases, the position information generation unit 27 may, in the case in which a distance has been calculated using multiple measurement units, ignore the position with the largest jitter width. Factors in reducing the measurement accuracy are, for example, due to the effects of performing transmission and reception to a probe target via relays. Such conditions regarding the jitter width may be set in the terrain policy information.

Additionally, in cases in which the position of a communication counterpart (probe target) is to be estimated, there are also cases in which the communication counterpart is a data center, etc. In such cases, as the terrain policy information, for example, locations near major roads and locations in which buildings generally do not exist (e.g., rice paddies) may be excluded, etc. For example, satellite photos may be stored in the terrain information DB 25. In such cases, the position information generation unit 27 may, based on the stored satellite photos and the positions, exclude positions at which buildings generally do not exist from among the candidates to be the position of the probe target. The position information generation unit 27 may acquire and use satellite photos from external devices or external systems.

### (Modified Examples of Sixth Embodiment)

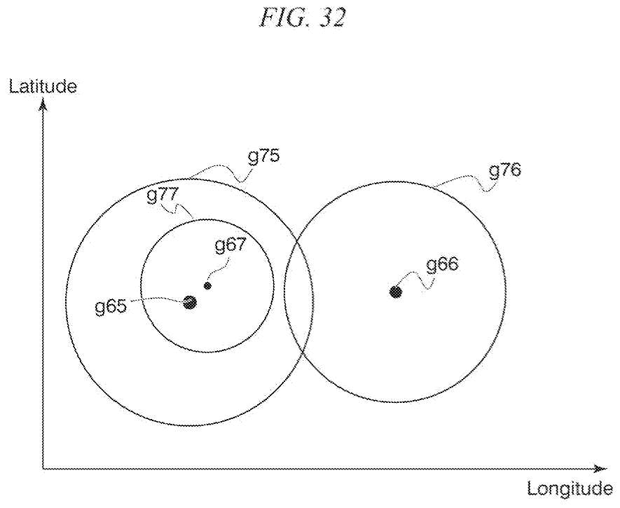

For example, in the examples indicated in FIG. 29 and FIG. 31, examples in which multiple circles indicating position ranges overlap were indicated. However, there may be cases in which the circles do not overlap, as shown in FIG. 32. FIG. 32 is an image diagram of the case in which circles of position ranges do not overlap. The reason why there are cases in which circles do not overlap is that there are cases in which a number of relays lie between the probe target and the measurement units, and the measurement units and the probe target are not connected by a line that is substantially straight but one that zigzags. In such a case, the straight-line distance becomes shorter than the actual distance. Thus, the circle becomes small, like the circle g77 in FIG. 32, and therefore, there are cases in which it does not overlap the circles g75, g76 of other position ranges. In such cases, according to FIG. 32, the case in which the circle g77 does not overlap or touch the other circles g75, g76 is indicated. In this case, the position information generation unit 27 may calculate the distances between the outer circumferences of the circles and may assume that the intersection points occur at the positions where the distances are the shortest. Thus, in the present embodiment, the intersection points include the areas of the positions at which the distances between the circumferences of position ranges are the shortest. Additionally, in the case in which there are many measurement units, the intersection points may be the positions at which the circles are densely concentrated. The position information generation unit 27 calculates the positions at which the circles are densely concentrated based on the positions of the circumferences, the central positions of the circumferences, the positions of the circumferences with respect to each other, etc.

### (First Modified Example)

In the respective embodiments described above, examples in which transmission timings and reception timings were used to calculate response times as if the probe targets and the measurement units are directly connected were explained. However, the disclosure is not limited thereto. For example, as mentioned above, there are cases in which there are relay devices in the middle or cases in which there are branching points (relay points). In such cases, the distance calculation unit 14 (or 14B and 14C) may determine the distance by using measurement values measured by multiple measurement units as well as by narrowing the position of the probe target, for example, by assuming that there is a hypothetical branching point such that the path branches between the first measurement unit and the distance measuring device 1F.

In the case in which there is a possibility that the path is branched, the distance calculation unit 14 may calculate the distance by assuming the number and positions of the relay points. For example, the distance calculation unit 14 may calculate the distance by weighting distances based on the number and positions of hypothetical relay points. Alternatively, the distance calculation unit 14 may transmit probe packets to the relay devices and acquire response times, and may calculate the distances to the relay devices based on the response times.

### (Second Modified Example)

In the respective embodiments mentioned above, the distance measuring device 1 (or 1A, 1B, 1C, 1D, 1E or 1F) may be provided with a timing synchronization unit for synchronizing the timing. The timing synchronization unit is, for example, a GPS (Global Positioning System) reception device.

In normal personal computers, clocks with quartz oscillators are used. However, these have an error of approximately 10 (μs) per second (because an error of approximately 1 second occurs per day). In contrast therewith, according to the modified example, this error can be minimized by providing a high-accuracy timing synchronization device such as a GPS reception unit, etc.

A program for realizing some or all of the functions of the distance measuring device 1 (or 1A, 1B, 1C, 1D, 1E, or 1F) in the present disclosure may be recorded in a computer-readable recording medium, and the program recorded in this recording medium may be read into a computer system and executed, thereby performing some or all of the processes performed by the distance measuring device 1 (or 1A, 1B, 1C, 1D, 1E, or 1F). The “computer system” mentioned here includes an OS and hardware such as peripheral devices. Additionally, a “computer system” includes a WWW system provided with a webpage-providing environment (or display environment). Additionally, the “computer-readable recording medium” refers to portable media such as flexible disks, magneto-optic disks, ROMs, and CD-ROMs, and storage devices, such as hard disks, internal to computer systems. Furthermore, “computer-readable recording medium” includes media that hold the program for a certain period of time, such as volatile memory (RAM) in computer systems serving as servers or clients in the case in which the program is transmitted over a network, such as the internet, or over a communication line such as a telephone line.

Additionally, the above-mentioned program may be transmitted from the computer system in which this program is stored, such as a storage device, to another computer system by means of a transmission medium or by transmission waves in a transmission medium. In this case, the “transmission medium” transmitting the program refers to a medium having the function of transmitting information, like a network (communication network), such as the internet, or a communication line (communication cable), such as a telephone line. Additionally, the above-described program may be for realizing just some of the aforementioned functions. Furthermore, it may be able to realize the aforementioned functions by being combined with a program that is already recorded in a computer system, i.e., a so-called difference file (difference program).

Modes for carrying out the present disclosure have been explained by using embodiments above. However, the present disclosure is not limited in any way by these embodiments, and various modifications and substitutions may be added within a range not departing from the spirit of the present disclosure.

(Appendix 1) A distance measuring device comprising:
measuring means for acquiring a transmission timing at which a probe packet was transmitted to a probe target, and a reception timing at which a response packet to the probe packet was received from the probe target;
response time calculating means for calculating a response time by using the transmission timing and the reception timing;
medium storing means for storing a medium velocity, which is a signal transmission velocity in a transmission medium used for transmission between the distance measuring device and the probe target; and
distance calculating means for calculating a distance to the probe target by using the response time and the medium velocity.

(Appendix 2) The distance measuring device according to appendix 1, wherein:
the measuring means comprises first measuring means and second measuring means that are installed at mutually different positions;
the response time calculating means comprises a first response time calculating means for calculating a first response time by using the transmission timing and the reception timing measured by the first measuring means, and a second response time calculating means for calculating a second response time by using the transmission timing and the reception timing measured by the second measuring means; and
the distance calculating means calculates a first distance between the first measuring means and the probe target by using the first response time and the medium velocity, and a second distance between the second measuring means and the probe target by using the second response time and the medium velocity.

(Appendix 3) The distance measuring device according to appendix 2, comprising
a medium velocity calculating means that calculates the medium velocity and stores the medium velocity in the medium storing means,
wherein:
an n-th (where n is 1 or 2) measuring means acquires a transmission timing at which a probe packet was transmitted to an m-th (where m is 1 or 2 and not equal to n) measuring means, and a reception timing at which a response packet to the probe packet was received from the m-th measuring means;
the n-th response time calculating means calculates a third response time from the n-th measuring means to the m-th measuring means by using the transmission timing and the reception timing measured by the n-th measuring means;
the medium velocity calculating means calculates a physical distance between the n-th measuring means and the m-th measuring means, calculates a third medium velocity between the n-th measuring means and the m-th measuring means by using the calculated physical distance and the third response time, and stores the calculated third medium velocity in the medium storing means; and
the distance calculating means calculates a distance between the n-th measuring means and a probe target at an unknown position by using the third medium velocity.

(Appendix 4) The distance measuring device according to appendix 1, wherein:
the measuring means comprises first measuring means and second measuring means that are installed at mutually different positions;
the response time calculating means comprises a first response time calculating means for calculating a first response time by using the transmission timing and the reception timing measured by the first measuring means, and a second response time calculating means for calculating a second response time by using the transmission timing and the reception timing measured by the second measuring means; and
the distance calculating means,
if the medium storing means stores a medium velocity relating to the probe target, calculates the distance by using the medium velocity relating to the probe target, and
if the medium storing means does not store the medium velocity relating to the probe target, calculates the distance by taking the medium velocity to be an average value of medium velocities based on results obtained by the first measuring means measuring other probe targets and an average value of medium velocities based on results obtained by the second measuring means measuring other probe targets, stored in the medium storing means.

(Appendix 5) The distance measuring device according to any one of appendix 1 to appendix 4, comprising
distance information generating means for generating presentation information for presenting information relating to the distance calculated by the distance calculating means,
wherein:
the distance information generating means generates the presentation information that is presented by adding information regarding a prescribed distance range from the distance.

(Appendix 6) The distance measuring device according to appendix 1, comprising
distance information generating means for generating presentation information for presenting information relating to the distance calculated by the distance calculating means,
wherein:
the distance information generating means generates the presentation information presenting a range in which the probe target is positioned by presenting the distance as a circle centered at the position of the distance measuring device and having a radius equal to the distance.

(Appendix 7) The distance measuring device according to appendix 2 or appendix 3, comprising
a distance information generating means for generating presentation information for presenting information relating to the distance calculated by the distance calculating means,
wherein:
the distance information generating means generates the presentation information for presenting a range in which the probe target is positioned by presenting a range in which the probe target is positioned by presenting the first distance as a first circle centered at the position of the first measuring means and having a radius equal to the first distance, and by presenting a range in which the probe target is positioned by presenting the second distance as a second circle centered at the position of the second measuring means and having a radius equal to the second distance.

(Appendix 8) The distance measuring device according to appendix 6 or appendix 7, wherein:
the distance information generating means generates the presentation information in which another circle having a radius that is a prescribed distance range from the distance is also added.

(Appendix 9) The distance measuring device according to appendix 7, wherein:
the distance information generating means generates the presentation information in which the range in which the probe target is positioned is presented based on at least one of an intersection, an overlap, and proximity between the first circle and the second circle.

(Appendix 10) The distance measuring device according to any one of appendix 5 to appendix 9, further comprising
position information generating means for generating position information regarding a position of the probe target based on information regarding terrain and selection conditions for selecting, from multiple candidate positions for the probe target based on the distance calculated by the distance calculating means, at least one of the multiple candidate positions,
wherein:
the distance information generating means generates the presentation information for presenting the position information generated by the position information generating means by adding the position information to a map.

(Appendix 11) The distance measuring device according to any one of appendix 1 to appendix 10, wherein:
the distance calculating means calculates a distance to the probe target by using a hypothetical relay point between the probe target and the measuring means.

(Appendix 12) A distance measuring method including:
acquiring a transmission timing at which a probe packet was transmitted to a probe target, and a reception timing at which a response packet to the probe packet was received from the probe target;
calculating a response time by using the transmission timing and the reception timing;
storing a medium velocity, which is a signal transmission velocity in a transmission medium used for transmission between a distance measuring device and the probe target; and
calculating a distance to the probe target by using the response time and the medium velocity.

(Appendix 13) A storage medium having a program stored thereon, the program making a computer execute a process, the process including:
acquiring a transmission timing at which a probe packet was transmitted to a probe target, and a reception timing at which a response packet to the probe packet was received from the probe target;
calculating a response time by using the transmission timing and the reception timing;
storing a medium velocity, which is a signal transmission velocity in a transmission medium used for transmission between a distance measuring device and the probe target; and
calculating a distance to the probe target by using the response time and the medium velocity.

This applications claims priority on the basis of Japanese Patent Application No. 2021-172487, filed on Oct. 21, 2021, and Japanese Patent Application No. 2022-031629, filed on Mar. 2, 2022, the disclosures of which are incorporated herein by reference.

### INDUSTRIAL APPLICABILITY

The present invention can measure distances to communication counterparts.

### REFERENCE SIGNS LIST

1, 1A, 1B, 1C, 1D, 1E, 1F Distance measuring device
2, 2A, 2B, 2C, 2D, 2E, 2F Distance measuring system
3 Display device
4 Probe target
5 Transmission medium
11, 11B, 11C, 11E Measurement unit
12, 12B, 12C, 12E Response time calculation unit
13, 13C, 13D Medium DB
14, 14B, 14C Distance calculation unit
15, 15B, 15C, 15C Distance information generation unit
16, 16C Measurement results DB
17, 17C Measuring device DB
18 Medium velocity calculation unit
19 Medium velocity selection unit
20 Calculation method DB
21 Calculation policy DB
25 Terrain information DB
26 Terrain policy DB
27 Position information generation unit

What is claimed is:

1. A distance measuring device comprising:
at least one measurer configured to acquire a transmission timing at which a probe packet was transmitted to a probe target, and a reception timing at which a response packet to the probe packet was received from the probe target;
at least one memory configured to store instructions, and a medium velocity, which is a signal transmission velocity in a transmission medium used for transmission between the distance measuring device and the probe target; and
at least one processor configured to execute the instructions to:
calculate a response time by using the transmission timing and the reception timing; and
calculate a distance to the probe target by using the response time and the medium velocity.

2. The distance measuring device according to claim 1, wherein:
the at least one measurer comprises first measurer and second measurer that are installed at mutually different positions;
wherein the at least one processor is configured to execute the instructions to:
calculate a first response time by using the transmission timing and the reception timing measured by the first measurer, and calculate a second response time by using the transmission timing and the reception timing measured by the second measurer; and
calculate a first distance between the first measurer and the probe target by using the first response time and the medium velocity, and a second distance between the second measurer and the probe target by using the second response time and the medium velocity.

3. The distance measuring device according to claim 2,
wherein the at least one processor is further configured to execute the instructions to:
calculate the medium velocity and store the medium velocity in the at least one memory,
wherein:
an n-th (where n is 1 or 2) measurer acquires a transmission timing at which a probe packet was transmitted to an m-th (where m is 1 or 2 not equal to n) measurer, and a reception timing at which a response packet to the probe packet was received from the m-th measurer;
wherein the at least one processor is configured to execute the instructions to:
calculate a third response time from the n-th measurer to the m-th measurer by using the transmission timing and the reception timing measured by the n-th measurer;
calculate a physical distance between the n-th measurer and the m-th measurer, calculate a third medium velocity between the n-th measurer and the m-th measurer by using the calculated physical distance and the third response time, and store the calculated third medium velocity in the at least one memory; and
calculate a distance between the n-th measurer and a probe target at an unknown position by using the third medium velocity.

4. The distance measuring device according to claim 1, wherein:
the at least one measurer comprises first measurer and second measurer that are installed at mutually different positions;
wherein the at least one processor is configured to execute the instructions to:
calculate a first response time by using the transmission timing and the reception timing measured by the first measurer, and calculate a second response time by using the transmission timing and the reception timing measured by the second measurer; and
if the at least one memory stores a medium velocity relating to the probe target, calculate the distance by using the medium velocity relating to the probe target, and
if the at least one memory does not store the medium velocity relating to the probe target, calculate the distance by taking the medium velocity to be an average value of medium velocities based on results obtained by the first measurer measuring other probe targets and an average value of medium velocities based on results obtained by the second measurer measuring other probe targets, stored in the at least one memory.

5. The distance measuring device according to claim 1,
wherein the at least one processor is further configured to execute the instructions to generate presentation information for presenting information relating to the calculated distance,
wherein the at least one processor is configured to execute the instructions to:
generate the presentation information that is presented by adding information regarding a prescribed distance range from the distance.

6. The distance measuring device according to claim 1,
wherein the at least one processor is further configured to execute the instructions to generate presentation information for presenting information relating to the calculated distance, and
wherein the at least one processor is configured to execute the instructions to:
generate the presentation information presenting a range in which the probe target is positioned by presenting the distance as a circle centered at the position of the distance measuring device and having a radius equal to the distance.

7. The distance measuring device according to claim 2,
wherein the at least one processor is further configured to execute the instructions to generate presentation information for presenting information relating to the calculated distance,
wherein the at least one processor is configured to execute the instructions to:
generate the presentation information for presenting a range in which the probe target is positioned by presenting a range in which the probe target is positioned by presenting the first distance as a first circle centered at the position of the first measurer and having a radius equal to the first distance, and by presenting a range in which the probe target is positioned by presenting the second distance as a second circle centered at the position of the second means and having a radius equal to the second distance.

8. The distance measuring device according to claim 6,
wherein the at least one processor is configured to execute the instructions to:
generate the presentation information in which another circle having a radius that is a prescribed distance range from the distance is also added.

9. The distance measuring device according to claim 7,
wherein the at least one processor is configured to execute the instructions to:
generate the presentation information in which the range in which the probe target is positioned is presented based on at least one of an intersection, an overlap, and proximity between the first circle and the second circle.

10. The distance measuring device according to claim 5,
wherein the at least one processor is further configured to execute the instructions to generate position information regarding a position of the probe target based on information regarding terrain and selection conditions for selecting, from multiple candidate positions for the probe target based on the calculated distance, at least one of the multiple candidate positions, and
wherein the at least one processor is configured to execute the instructions to:
generate the presentation information for presenting the generated position information by adding the position information to a map.

11. The distance measuring device according to claim 1,
wherein the at least one processor is configured to execute the instructions to:
calculate a distance to the probe target by using a hypothetical relay point between the probe target and the at least one measurer.

12. A distance measuring method executed by a distance measuring device, the distance measuring method comprising:
acquiring, by at least one measurer, a transmission timing at which a probe packet was transmitted to a probe target, and a reception timing at which a response packet to the probe packet was received from the probe target;
calculating a response time by using the transmission timing and the reception timing;
storing a medium velocity, which is a signal transmission velocity in a transmission medium used for transmission between the distance measuring device and the probe target; and
calculating a distance to the probe target by using the response time and the medium velocity.

13. A non-transitory storage medium having a program stored thereon, the program making a computer of a distance measuring device execute a process, the process comprising:
acquiring a transmission timing at which a probe packet was transmitted to a probe target, and a reception timing at which a response packet to the probe packet was received from the probe target;
calculating a response time by using the transmission timing and the reception timing;
storing a medium velocity, which is a signal transmission velocity in a transmission medium used for transmission between the distance measuring device and the probe target; and
calculating a distance to the probe target by using the response time and the medium velocity.

14. The distance measuring method according to claim 12, wherein:
the at least one measurer comprises first measurer and second measurer that are installed at mutually different positions;
the calculating of the response time includes
calculating a first response time by using the transmission timing and the reception timing measured by the first measurer, and calculating a second response time by using the transmission timing and the reception timing measured by the second measurer; and
the calculating of the distance includes
calculating a first distance between the first measurer and the probe target by using the first response time and the medium velocity, and a second distance between the second measurer and the probe target by using the second response time and the medium velocity.

15. The distance measuring method according to claim 14, further comprising
calculating the medium velocity and storing the medium velocity in the memory,
wherein the acquiring includes
acquiring, by an n-th (where n is 1 or 2) measurer, a transmission timing at which a probe packet was transmitted to an m-th (where m is 1 or 2 not equal to n) measurer, and a reception timing at which a response packet to the probe packet was received from the m-th measurer,
the calculating of the response time includes
calculating a third response time from the n-th measurer to the m-th measurer by using the transmission timing and the reception timing measured by the n-th measurer,
the calculating of the medium velocity includes
calculating a physical distance between the n-th measurer and the m-th measurer, calculating a third medium velocity between the n-th measurer and the m-th measurer by using the calculated physical distance and the third response time, and storing the calculated third medium velocity in the memory, and
the calculating of the distance includes
calculating a distance between the n-th measurer and a probe target at an unknown position by using the third medium velocity.

16. The distance measuring method according to claim 12, wherein:
the at least one measurer comprises first measurer and second measurer that are installed at mutually different positions;
the calculating of the response time includes
calculating a first response time by using the transmission timing and the reception timing measured by the first measurer, and calculating a second response time by using the transmission timing and the reception timing measured by the second measurer; and
the calculating of the distance includes
if a medium velocity relating to the probe target is stored in the memory, calculating the distance by using the medium velocity relating to the probe target, and
if the medium velocity relating to the probe target is not stored in the memory, calculating the distance by taking the medium velocity to be an average value of medium velocities based on results obtained by the first measurer measuring other probe targets and an average value of medium velocities based on results obtained by the second measurer measuring other probe targets, stored in the memory.

17. The distance measuring method according to claim 12, further comprising:
generating presentation information for presenting information relating to the calculated distance,
wherein the generating of the presentation information includes
generating the presentation information that is presented by adding information regarding a prescribed distance range from the distance.

18. The distance measuring method according to claim 12, further comprising:
generating presentation information for presenting information relating to the calculated distance,
wherein the generating of the presentation information includes
generating the presentation information presenting a range in which the probe target is positioned by presenting the distance as a circle centered at the position of the distance measuring device and having a radius equal to the distance.

19. The distance measuring method according to claim 14, further comprising:
generating presentation information for presenting information relating to the calculated distance,
wherein the generating of the presentation information includes
generating the presentation information for presenting a range in which the probe target is positioned by presenting a range in which the probe target is positioned by presenting the first distance as a first circle centered at the position of the first measurer and having a radius equal to the first distance, and by presenting a range in which the probe target is positioned by presenting the second distance as a second circle centered at the position of the second measurer and having a radius equal to the second distance.

20. The distance measuring method according to claim 18,
wherein the generating of the presentation information includes
generating the presentation information in which another circle having a radius that is a prescribed distance range from the distance is also added.

21. The distance measuring method according to claim 19,
wherein the generating of the presentation information includes
generating the presentation information in which the range in which the probe target is positioned is presented based on at least one of an intersection, an overlap, and proximity between the first circle and the second circle.

22. The distance measuring method according to claim 17, further comprising
generating position information regarding a position of the probe target based on information regarding terrain and selection conditions for selecting, from multiple candidate positions for the probe target based on the calculated distance, at least one of the multiple candidate positions,
wherein the generating of the presentation information includes
generating the presentation information for presenting the generated position information by adding the position information to a map.

23. The distance measuring method according to claim 12,
wherein the calculating of the distance includes
calculating a distance to the probe target by using a hypothetical relay point between the probe target and the at least one measurer.
